(19) United States
(12) Patent Application Publication
(10) Pub. No.: US 2021/0216773 A1
(43) Pub. Date: Jul. 15, 2021

(54) PERSONAL PROTECTIVE EQUIPMENT SYSTEM WITH AUGMENTED REALITY FOR SAFETY EVENT DETECTION AND VISUALIZATION

(71) Applicant: 3M INNOVATIVE PROPERTIES COMPANY, St. Paul, MN (US)

(72) Inventors: Kandyce M. Bohannon, White Bear Lake, MN (US); Britton G. Billingsley, St. Paul, MN (US); Matthew J. Blackford, Hastings, MN (US); Ronald D. Jesme, Plymouth, MN (US); Johannes P.M. Kusters, Austin, TX (US); Caroline M. Ylitalo, Stillwater, MN (US)

(21) Appl. No.: 17/250,012

(22) PCT Filed: May 1, 2019
(86) PCT No.: PCT/IB2019/053558

§ 371 Date: Nov. 2, 2020

Related U.S. Application Data
(60) Provisional application No. 62/666,593, filed on May 3, 2018.

(51) Int. Cl. G06K 9/00; G06F 3/01; G06T 11/00

(52) U.S. Cl. CPC G06K 9/00671; G06T 11/00; G06F 3/017

(57) ABSTRACT

In some examples, a system includes an article of personal protective equipment (PPE) configured to present an (AR) augmented reality display to a user and at least one computing device. The computing device may include a memory and one or more processors coupled to the memory. The memory may include instructions that when executed by the one or more processors identify a field of view of the user, determine information relating to the field of view of the user, generate one or more indicator images related to the determined information of the field of view, and generate the AR display including at least the one or more indicator images.

### TECHNICAL FIELD

The present disclosure relates to the field of personal protective equipment.

### BACKGROUND

Personal protective equipment (PPE) may be used to help protect a user (e.g., a worker) from harm or injury from a variety of causes. For example, workers may wear eye protection, such as safety glasses, in many different work environments. As another example, workers may use fall protection equipment when operating at potentially harmful or even deadly heights. As yet another example, when working in areas where there is known to be, or there is a potential of there being, dusts, fumes, gases or other contaminants that are potentially hazardous or harmful to health, it is usual for a worker to use a respirator or a clean air supply source, such as a powered air purifying respirators (PAPR) or a self-contained breathing apparatus (SCBA). Other PPE may include, as non-limiting examples, hearing protection, head protection (e.g., visors, hard hats, or the like), protective clothing, or the like. In some cases, worker may not recognize an impending safety event until the environment becomes too dangerous or the worker's health deteriorates too far.

### SUMMARY

The present disclosure describes articles, systems, and methods that enable presentation of an augmented reality display of a work environment via an article of personal protection equipment (PPE). For example, safety glasses, a welding mask, a face shield, or another article of PPE may be configured to display an augmented reality view of a work environment in which a worker is viewing (e.g., through the article of PPE).

As one example, a variety of PPEs and/or other components of a work environment may be fitted with electronic sensors that generate streams of data regarding status or operation of the PPE, environmental conditions within regions of the work environment, and the like. A worker safety management system executing in a computing environment includes analytical stream processing engine configured to detect conditions in the stream of data, such as by processing the stream of PPE data in accordance with one or more models. Based on the conditions detected by the analytical stream processing engine and/or conditions reported or otherwise detected in a particular work environment, the worker safety management system generates visualization information to be displayed to individuals (e.g., workers of safety managers) within the work environment in real-time or pseudo real-time based on the particular location and orientation of the augmented reality display device associated with the individual.

In some examples, the augmented reality display may present one or more indicators with respect to the work environment. For instance, the augmented reality display may present indicators relating to potential hazards within the work environment, information pertaining to one or more workers within the work environment, such as PPE compliance or training status of the workers, information about a machine or another piece of equipment, a list of tasks, or the like as an overlay on the actual work environment the worker is looking at. In this way, the techniques described herein may alert a worker (e.g., a worker wearing the article of PPE configured to present the augmented reality display) of potentially dangerous situations within the work environment, as well as present information that may be useful to the worker's productivity within the work environment. Thus, the techniques described herein may help prevent and/or reduce safety events, increase PPE compliance of workers, increase productivity of workers, or the like.

In one example, a system includes an article of personal protective equipment (PPE) configured to present an (AR) augmented reality display to a user and at least one computing device. The computing device may include a memory and one or more processors coupled to the memory. The memory may include instructions that when executed by the one or more processors identify a field of view of the user, determine information relating to the field of view of the user, generate one or more indicator images related to the determined information of the field of view, and generate the AR display including at least the one or more indicator images.

In another example, a method includes identifying a field of view of a user, determining information relating to the field of view of the user, generating one or more indicator images related to the determined information of the field of view, and generating an augmented reality (AR) display including at least the one or more indicator images.

In yet another example, an article of personal protective equipment (PPE) includes a camera configured to capture a field of view of a user of the article of PPE, a display configured to present an augmented reality (AR) display to the user, and at least one computing device communicatively coupled to the camera. The at least one computing device includes a memory and one or more processors coupled to the memory. The memory includes instructions that when executed by the one or more processors capture, via the camera, information representative of the field of view of the user; receive one or more indicator images, where the one or more indicator images are related to information about of the captured field of view, and present, via the display, the AR display including at least the one or more indicator images.

In yet another example, a computing device includes a memory and one or more processors coupled to the memory. The one or more processors are configured to identify a field of view of a user of an article of personal protection equipment (PPE), determine information relating to the field of view of the user, generate one or more indicator images related to the determined information of the field of view, and send at least the one or more indicator images to the article of PPE.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example computing system that includes a worker safety management system (WSMS) for managing safety of workers within a work environment in which augmented reality display devices of the workers provide enhanced safety information, in accordance with various techniques of this disclosure.

FIG. 2 is a block diagram providing an operating perspective of WSMS when hosted as a cloud-based platform capable of supporting multiple, distinct work environments having an overall population of workers equipped with augmented reality display devices, in accordance with various techniques of this disclosure.

FIG. 3 is a block diagram illustrating an example augmented reality display device configured to present an AR display of a field of view of a work environment, in accordance with various techniques of this disclosure.

FIG. 4 is a conceptual diagram illustrating an example AR display presented via an augmented reality display device that includes a field of view as seen through the augmented reality display device and indicator images designating a safety event and a potential hazard, in accordance with the techniques of this disclosure.

FIG. 5 is a conceptual diagram illustrating another example AR display presented via an augmented reality display devicees that includes a field of view as seen through the augmented reality display device and indicator images designating PPE compliance of workers, in accordance with various techniques of this disclosure.

FIG. 6A is a conceptual diagram illustrating yet another AR display in which a worker is performing a gesture input, in accordance with various techniques of this disclosure.

FIG. 6B is a conceptual diagram illustrating an example AR display after a plurality of indicator images have been placed within a field of view using gesture inputs, in accordance with various techniques of this disclosure.

FIG. 7 is a conceptual diagram illustrating yet another example AR display presented via an augmented reality display device that includes a field of view as seen through the augmented reality display device and indicator images providing information relating to a machine, in accordance with various techniques of the disclosure.

FIG. 8 is a conceptual diagram illustrating yet another example AR display presented via an augmented reality display device that includes a field of view as seen through the augmented reality display device and indicator images designating paths through the field of view, in accordance with various techniques of the disclosure.

FIG. 9 is a conceptual diagram illustrating yet another example AR display presented via an augmented reality display device that includes a field of view as seen through the augmented reality display device and indicator images configured to provide additional information about low-visibility or non-visible aspects of the field of view and an indicator image configured to obscure a portion of the field of view, in accordance with various techniques of the disclosure.

FIG. 10 is a flow diagram illustrating an example technique of presenting an AR display on an augmented reality display device, in accordance with various techniques of the disclosure.

It is to be understood that the examples may be utilized and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure describes articles, systems, and methods that enable presentation of an augmented reality display of a work environment via an article of personal protection equipment (PPE). The techniques described herein for presenting an augmented reality (AR) display via an article of personal protection equipment (PPE) may help reduce or prevent safety events, provide helpful information to a worker, improve PPE compliance, productivity, and/or overall safety of a work environment, or the like. A worker in a work environment may be exposed to various hazards or safety events (e.g., air contamination, heat, falls, etc.). In some examples, a worker may utilize an article of PPE configured to present an AR display of the work environment that may indicate safety events, potential hazards, training and/or PPE compliance of workers, information related to particular worker or work environment, or combinations thereof. For example, a worker safety management system may be configured to determine relevant information relating to a field of view of the work environment as seen by the worker through the article of PPE, and the article of PPE may be configured to present such information or otherwise alert the worker via the AR display present on the article of PPE. In some examples, the AR display may display at least a portion of the field of view (e.g., as seen through the article of PPE) and overlay one or more indicator images or information over the field of view such that the AR display combines a real-world field of view with computer-generated images. In addition, a worker may be able to provide information via the article of PPE to the worker safety management system, such as information indicating environmental conditions, safety events, and/or potential hazards.

In some example implementations, the AR displays associated with workers utilizing PPEs within the work environment may be controlled by worker safety management system in conjunction with an analytical stream processing engine configured to detect conditions in streams of data provided by sensors within the PPE as well as sensors located within the environment. Based on the conditions detected by the analytical stream processing engine and/or conditions reported or otherwise detected in the particular work environment, the worker safety management system generates visualization information to be displayed to individuals (e.g., workers or safety managers) within the work environment in real-time or pseudo real-time based on the particular pose (location and orientation) of the augmented reality display device associated with the individual.

The techniques described herein may enable a worker safety management system to improve worker safety and provide technical advantages over other systems by, for example, providing real-time alerts relating to safety, compliance, potential hazards, or the like to workers based on a worker's field of view through an article of PPE configured to present an AR display of the work environment. The techniques may, for example, provide enhanced AR information based on trends and conditions determined by analytical stream processing the data collected from the PPEs and/or other sensors, thereby providing AR views not otherwise available. As one example illustrating the technical improvements described herein, analytical processing of the streams of data may be used to identify trends indicative of a safety or risk state (e.g., at risk) of a particular worker or a safety or risk state (e.g., dangerous) region or object within the work environment, and enhanced AR information for display by the AR displays of PPEs within the environment can be generated.

As another example, the articles, systems, and techniques described herein may help enable corrective action to be taken prior to the occurrence of a safety event. For instance, a supervisor may be able to correct PPE non-compliance of a worker before the worker begins a work task. As another example, the article of PPE may enable workers to indicate potential safety hazards to the worker safety management system so that other workers within the vicinity of the potential hazard may be notified of the potential hazard. Moreover, the articles, systems, and techniques described herein may provide additional or alternative information and/or functions not pertaining to safety via the AR display of the article of PPE. For example, the article of PPE may present information about tasks to be completed, locations or paths of other workers, navigation information, diagnostic information, instructions. Additionally, or alternatively, the article of PPE may obscure distracting motion or objects from the field of view, allow the worker to annotate the field of view, determine if the worker is paying attention to a certain task or object, or combinations thereof.

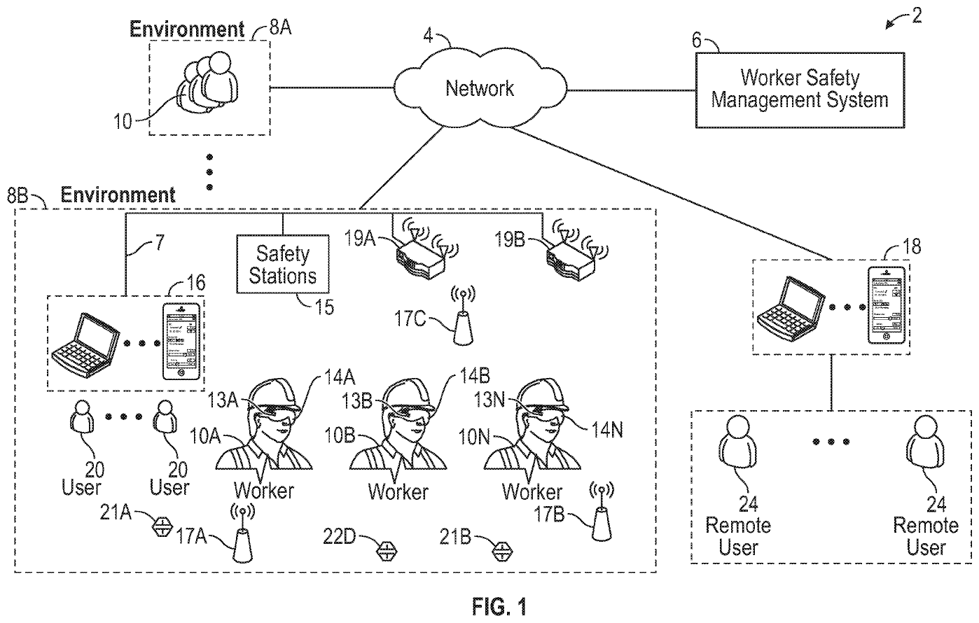

FIG. 1 is a block diagram illustrating an example computing system 2 that includes a worker safety management system (WSMS) 6 for managing safety of workers 10A-10N (collectively, “workers 10”) within work environment 8A, 8B (collectively, “work environment 8”), in accordance with various techniques of this disclosure. As described herein, WSMS 6 provides information related to safety events, potential hazards, workers 10, machines, or other information relating to work environment 8 to an article of PPE configured to present an AR display. In other examples, one or more of workers 10 may utilize an AR display separate from one or more PPEs worn by the worker. In this example, the article of PPE configured to present the AR display will be described herein as “safety glasses” (e.g., safety glasses 14A-14N as illustrated in FIG. 1). In other examples, however, the article of PPE configured to present the AR display may include additional or alternative articles of PPE, such as welding helmets, face masks, face shields, or the like. By interacting with WSMS 6, safety professionals can, for example, evaluate and view safety events, manage area inspections, worker inspections, worker health, and PPE compliance.

In general, WSMS 6 provides data acquisition, monitoring, activity logging, reporting, predictive analytics, PPE control, generation and maintenance of data for controlling AR overlay presentation and visualization, and alert generation. For example, WSMS 6 includes an underlying analytics and worker safety management engine and alerting system in accordance with various examples described herein. In general, a safety event may refer to an environmental condition (e.g., which may be hazardous), activities of a user of PPE, a condition of an article of PPE, or another event which may be harmful to the safety and/or health of a worker. In some examples, a safety event may be an injury or worker condition, workplace harm, a hazardous environmental condition, or a regulatory violation. For example, in the context of fall protection equipment, a safety event may be misuse of fall protection equipment, a user of the fall equipment experiencing a fall, or a failure of the fall protection equipment. In the context of a respirator, a safety event may be misuse of the respirator, a user of the respirator not receiving an appropriate quality and/or quantity of air, or failure of the respirator. A safety event may also be associated with a hazard in the environment in which the PPE is located, such as, for example, poor air quality, presence of a contaminant, a status of a machine or piece of equipment, a fire, or the like.

As further described below, WSMS 6 provides an integrated suite of worker safety management tools and implements various techniques of this disclosure. That is, WSMS 6 provides an integrated, end-to-end system for managing worker safety, within one or more physical work environments 8, which may be construction sites, mining or manufacturing sites, or any physical environment. The techniques of this disclosure may be realized within various parts of system 2.

As shown in the example of FIG. 1, system 2 represents a computing environment in which a computing device within of a plurality of physical work environments 8 electronically communicate with WSMS 6 via one or more computer networks 4. Each of work environment 8 represents a physical environment in which one or more individuals, such as workers 10, utilize PPE while engaging in tasks or activities within the respective environment.

In this example, environment 8A is shown as generally as having workers 10, while environment 8B is shown in expanded form to provide a more detailed example. In the example of FIG. 1, a plurality of workers 10A-10N are shown as utilizing respective safety glasses 14A-14N (collectively, “safety glasses 14”). In accordance with the techniques of the disclosure, safety glasses 14 are configured to present an AR display of a field of view of the work environment that worker 10 is seeing through the respective safety glasses 14.

That is, safety glasses 14 are configured to present at least a portion of the field of view of the respective worker 10 through safety glasses 14 as well as any information determined to be relevant to the field of view by WSMS 6 (e.g., one or more indicator images). For instance, safety glasses 14 may include a camera or another sensor configured to capture the field of view (or information representative of the field of view) in real time or near real time. In some examples, the captured field of view and/or information representative of the field of view may be sent to WSMS 6 for analysis. In other examples, data indicating a position and orientation information (i.e., a pose) associated with the field of view may be communicated to WSMS 6. Based on the particular field of view of the safety glasses 14 (e.g., as determined from the position and orientation data), WSMS 6 may determine additional information pertaining to the current field of view of the worker 10 for presentation to the user. In some examples, the information relating to the field of view may include potential hazards, safety events, machine or equipment information, navigation information, instructions, diagnostic information, information about other workers 10, information relating to a job task, information related to one or more articles of PPE, or the like within the field of view. If WSMS 6 determines information relevant to the worker's field of view, WSMS 6 may generate one or more indicator images related to the determined information. For instance, WSMS 6 may generate a symbol, a notification or alert, a path, a list, or another indicator image that can be used as part of the AR display via safety glasses 14. WSMS 6 may send the indicator images, or an AR display including the one or more indicator images, to safety glasses 14 for display. In other examples, WSMS 6 outputs data indicative of the additional information, such as an identifier of the information as well as a position within the view for rendering the information, thereby instructing safety glasses 14 to construct the composite image to be presented by the AR display. Safety glasses 14 may then present an enhanced AR view to worker 10 on the AR display.

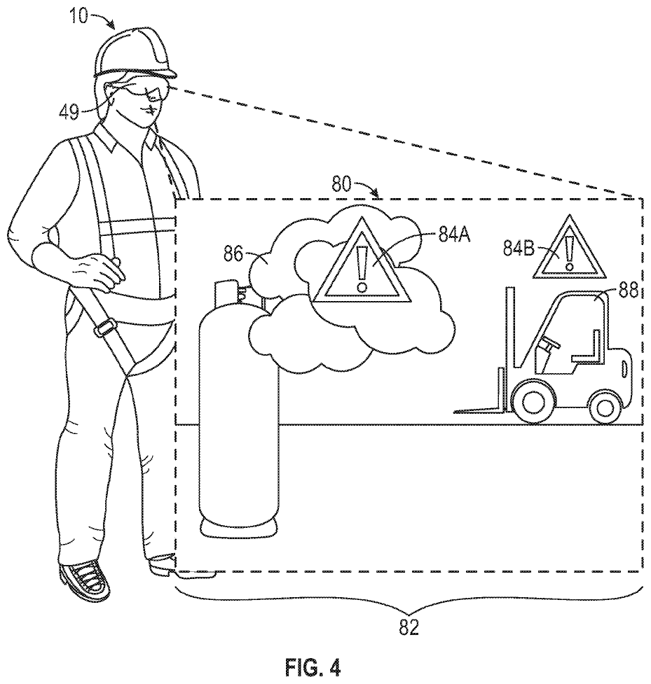

In this way, the AR display may include a direct or indirect live view of the real, physical work environment 8B as well as augmented computer-generated information. The augmented computer-generated information may be overlaid on the live view (e.g., field of view) of work environment 8B. In some cases, the computer-generated information may be constructive to the live field of view (e.g., additive to the real-world work environment 8B). Additionally, or alternatively, the computer-generated information may be destructive to the live field of view (e.g., masking a portion of the real-world field of view). In some examples, the computer-generated information is displayed as an immersive portion of the real work environment 8B. For instance, the computer-generated information may be spatially registered with the components within the field of view. In some such examples, worker 10 viewing work environment 8B via the AR display of safety glasses 14 may have an altered perception of work environment 8B. In other words, the AR display may present the computer-generated information as a cohesive part of the field of view such that the computer-generated information may seem like an actual component of the real-world field of view. Moreover, the image data for rendering by the AR display may be constructed locally by components within safety glasses 14 in response to data and commands received from WSMS 6 identifying and positioning the AR elements within the view. Alternatively, all or portions of the image data may be constructed remotely. Examples of AR displays presented by safety glasses 14 in accordance with the techniques of the disclosure will be described in more detail with respect to FIGS. 4-9.

As further described herein, each of safety glasses 14 may include embedded sensors or monitoring devices and processing electronics configured to capture data in real-time as a user (e.g., worker) engages in activities while wearing safety glasses 14. For example, safety glasses 14 may include one or more sensors for sensing a field of view of worker 10 wearing the respective safety glasses 14. In some such examples, safety glasses 14 may include a camera to determine the field of view of worker 10. For instance, the camera may be configured to determine a live field of view that worker 10 is seeing in real time or near real time while looking through safety glasses 14.

In addition, each of safety glasses 14 may include one or more output devices for outputting data that is indicative of information relating to the field of view of worker 10. For example, safety glasses 14 may include one or more output devices to generate visual feedback, such as the AR display. In some such examples, the one or more output devices may include one or more displays, light emitting diodes (LEDs), or the like. Additionally, or alternatively, safety glasses 14 may include one or more output devices to generate audible feedback (e.g., one or more speakers), tactile feedback (e.g., a device that vibrates or provides other haptic feedback), or both. In some examples, safety glasses 14 (or WSMS 6) may be communicatively coupled to one or more other articles of PPE configured to generate visual, audible, and/or tactile feedback.

In general, each of work environments 8 include computing facilities (e.g., a local area network) by which safety glasses 14 are able to communicate with WSMS 6. For example, work environments 8 may be configured with wireless technology, such as 802.11 wireless networks, 802.15 ZigBee networks, or the like. In the example of FIG. 1, environment 8B includes a local network 7 that provides a packet-based transport medium for communicating with WSMS 6 via network 4. In addition, environment 8B includes a plurality of wireless access points 19A, 19B (collectively, “wireless access points 19”) that may be geographically distributed throughout the environment to provide support for wireless communications throughout work environment 8B.

Each of safety glasses 14 is configured to communicate data, such as captured field of views, data, events, conditions, and/or gestures via wireless communications, such as via 802.11 WiFi protocols, Bluetooth protocol or the like. Safety glasses 14 may, for example, communicate directly with a wireless access point 19. As another example, each worker 10 may be equipped with a respective one of wearable communication hubs 13A-13N (collectively, “communication hubs 13”) that enable and facilitate communication between safety glasses 14 and WSMS 6. For example, safety glasses 14 as well as other PPEs (such as fall protection equipment, hearing protection, hardhats, or other equipment) for the respective worker 10 may communicate with a respective communication hub 13 via Bluetooth or other short range protocol, and communication hubs 13 may communicate with PPEMs 6 via wireless communications processed by wireless access points 19. In some examples, as illustrated in FIG. 1, communication hubs 13 may be a component of safety glasses 14. In other examples, communication hubs 13 may be implemented as wearable devices, stand-alone devices deployed within environment 8B, or a component of a different article of PPE.

In general, each of communication hubs 13 operates as a wireless device for safety glasses 14 relaying communications to and from safety glasses 14, and may be capable of buffering data in case communication is lost with WSMS 6. Moreover, each of communication hubs 13 is programmable via WSMS 6 so that local rules may be installed and executed without requiring a connection to the cloud. As such, each of communication hubs 13 may provide a relay of streams of data (e.g., data representative of a field of view) from safety glasses 14 within the respective environment 8B, and provides a local computing environment for localized determination of information relating to the field of view based on streams of events in the event communication with WSMS 6 is lost.

As shown in the example of FIG. 1, environment 8B may also include one or more wireless-enabled beacons 17A-17C (collectively, “beacons 17”) that provide accurate location information within work environment 8B. For example, beacons 17 may be GPS-enabled such that a controller within the respective beacon 17 may be able to precisely determine the position of the respective beacon 17. Based on wireless communications with one or more of beacons 17, a given pair of safety glasses 14 or communication hub 13 worn by a worker 10 may be configured to determine a location of the worker 10 within work environment 8B. In this way, data relating to the field of view of the worker 10 reported to WSMS 6 may be stamped with positional information to aid analysis, reporting, and analytics performed by WSMS 6.

In addition, environment 8B may also include one or more wireless-enabled sensing stations 21A, 21B (collectively, “sensing stations 21”). Each sensing station 21 includes one or more sensors and a controller configured to output data indicative of sensed environmental conditions. Moreover, sensing stations 21 may be positioned within respective geographic regions of environment 8B or otherwise interact with beacons 17 to determine respective positions and include such positional information when reporting environmental data to WSMS 6. As such, WSMS 6 may be configured to correlate the sensed environmental conditions with the particular regions and, therefore, may utilize the captured environmental data when processing field of view data received from safety glasses 14. For example, WSMS 6 may utilize the environmental data to aid in determining relevant information relating to the field of view (e.g., for presentation on the AR display), generating alerts, providing instructions, and/or performing predictive analytics, such as determining any correlations between certain environmental conditions (e.g., heat, humidity, visibility) with abnormal worker behavior or increased safety events. As such, WSMS 6 may utilize current environmental conditions to aid in generation of indicator images for the AR display, notify workers 10 of the environmental conditions or safety events, as well as aid in the prediction and avoidance of imminent safety events. Example environmental conditions that may be sensed by sensing stations 21 include but are not limited to temperature, humidity, presence of gas, pressure, visibility, wind, or the like.

In some examples, environment 8B may include one or more safety stations 15 distributed throughout the environment to provide viewing stations for accessing safety glasses 14. Safety stations 15 may allow one of workers 10 to check out safety glasses 14 and/or other safety equipment, verify that safety equipment is appropriate for a particular one of environments 8, and/or exchange data. For example, safety stations 15 may transmit alert rules, software updates, or firmware updates to safety glasses 14 or other equipment. Safety stations 15 may also receive data cached on safety glasses 14, communication hubs 13, and/or other safety equipment. That is, while safety glasses 14 (and/or communication hubs 13) may typically transmit data representative of the field of views of a worker 10 wearing safety glasses 14 to network 4 in real time or near real time, in some instances, safety glasses 14 (and/or communication hubs 13) may not have connectivity to network 4. In such instances, safety glasses 14 (and/or communication hubs 13) may store field of view data locally and transmit the data to safety stations 15 upon being in proximity with safety stations 15. Safety stations 15 may then upload the data from safety glasses 14 and connect to network 4.

In addition, each of environments 8 include computing facilities that provide an operating environment for end-user computing devices 16 for interacting with WSMS 6 via network 4. For example, each of environments 8 typically includes one or more safety managers responsible for overseeing safety compliance within the environment 8. In general, each user 20 may interact with computing devices 16 to access WSMS 6. Similarly, remote users 24 may use computing devices 18 to interact with WSMS 6 via network 4. For purposes of example, the end-user computing devices 16 may be laptops, desktop computers, mobile devices, such as tablets or so-called smart phones, or the like.

Users 20, 24 may interact with WSMS 6 to control and actively manage many aspects of worker safety, such as accessing and viewing field of view data, determination of information relating to the field of views, analytics, and/or reporting. For example, users 20, 24 may review information acquired, determined, and/or stored by WSMS 6. In addition, users 20, 24 may interact with WSMS 6 to update worker training, input a safety event, provide task lists for workers, or the like.

Further, as described herein, WSMS 6 integrates an event processing platform configured to process thousand or even millions of concurrent streams of events from digitally enabled PPEs, such as safety glasses 14. An underlying analytics engine of WSMS 6 may apply historical data and models to the inbound streams to determine information relevant to a field of view of a worker 10, such as predicted occurrences of safety events, vicinity of workers 10 to a potential hazard, behavioral patterns of the worker 10, or the like. Further, WSMS 6 provides real time alerting and reporting to notify workers 10 and/or users 20, 24 of any potential hazards, safety events, anomalies, trends, or other information may be useful to worker 10 viewing a specific area of work environment 8B via the AR display. The analytics engine of WSMS 6 may, in some examples, apply analytics to identify relationships or correlations between sensed field of views, environmental conditions, geographic regions, and other factors and analyze whether to provide one or more indicator images to worker 10 via the AR display about the respective field of view.

In this way, WSMS 6 tightly integrates comprehensive tools for managing worker safety with an underlying analytics engine and communication system to provide data acquisition, monitoring, activity logging, reporting, behavior analytics, and alert generation. Moreover, WSMS 6 provides a communication system for operation and utilization by and between the various elements of system 2. Users 20, 24 may access WSMS 6 to view results on any analytics performed by WSMS 6 on data acquired from workers 10. In some examples, WSMS 6 may present a web-based interface via a web server (e.g., an HTTP server) or client-side applications may be deployed for devices of computing devices 16, 18 used by users 20, 24, such as desktop computers, laptop computers, mobile devices, such as smartphones and tablets, or the like.

In some examples, WSMS 6 may provide a database query engine for directly querying WSMS 6 to view acquired safety information, compliance information, and any results of the analytic engine, e.g., by the way of dashboards, alert notifications, reports or the like. That is, users 24, 26, or software executing on computing devices 16, 18, may submit queries to WSMS 6 and receive data corresponding to the queries for presentation in the form of one or more reports or dashboards. Such dashboards may provide various insights regarding system 2, such as identifications of any geographic regions within environments 2 for which unusually anomalous (e.g., high) safety events have been or are predicted to occur, identifications of any of environments 2 exhibiting anomalous occurrences of safety events relative to other environments, PPE compliance of workers, potential hazards indicated by workers 10, or the like.

As illustrated in detail below, WSMS 6 may simplify managing worker safety. That is, the techniques of this disclosure may enable active safety management and allow an organization to take preventative or correction actions with respect to certain regions within environments 8, potential hazards, particular pieces of safety equipment, or individual workers 10, define and may further allow the entity to implement workflow procedures that are data-driven by an underlying analytical engine. Further example details of PPEs and worker safety management systems having analytical engines for processing streams of data are described in PCT Patent Application PCT/US2017/039014, filed Jun. 23, 2017, U.S. application Ser. No. 15/190,564, filed Jun. 23, 2016 and U.S. Provisional Application 62/408,634 filed Oct. 14, 2016, the entire content of each of which are hereby expressly incorporated by reference herein.

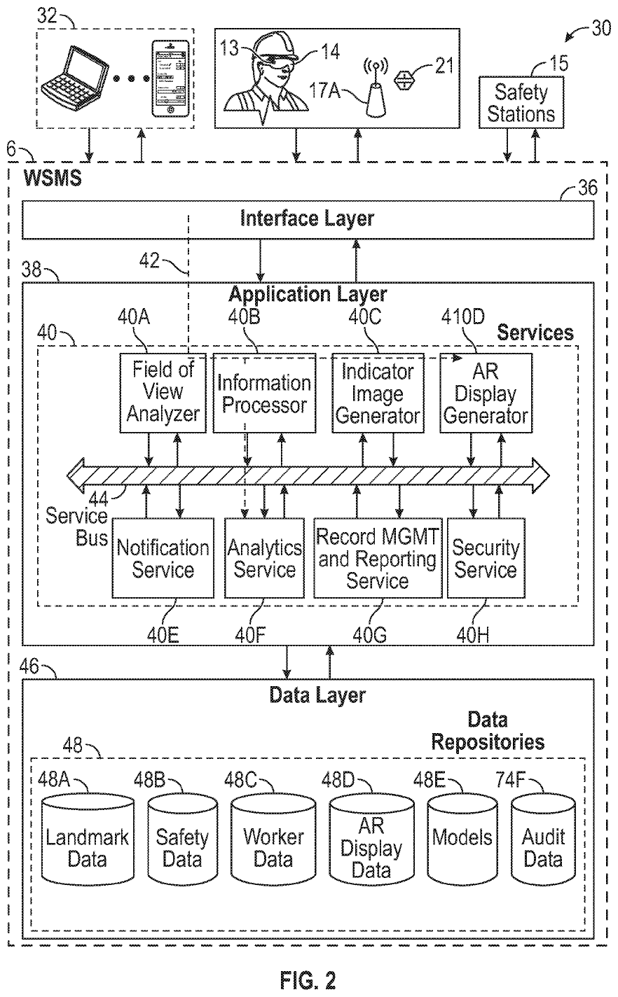

FIG. 2 is a block diagram providing an operating perspective of WSMS 6 when hosted as a cloud-based platform capable of supporting multiple, distinct work environments 8 having an overall population of workers 10 equipped with safety glasses 14, in accordance with various techniques of this disclosure. In the example of FIG. 2, the components of WSMS 6 are arranged according to multiple logical layers that implement the techniques of the disclosure. Each layer may be implemented by one or more modules and may include hardware, software, or a combination of hardware and software.

In some examples, computing devices 32, safety glasses 14, communication hubs 13, beacons 17, sensing stations 21, and/or safety stations 15 operate as clients 30 that communicate with WSMS 6 via interface layer 36. Computing devices 32 typically execute client software applications, such as desktop applications, mobile applications, and/or web applications. Computing devices 32 may represent any of computing devices 16, 18 of FIG. 1. Examples of computing devices 32 may include, but are not limited to, a portable or mobile computing device (e.g., smartphone, wearable computing device, tablet), laptop computers, desktop computers, smart television platforms, and/or servers.

In some examples, computing devices 32, safety glasses 14, communication hubs 13, beacons 17, sensing stations 21, and/or safety stations 15 may communicate with WSMS 6 to send and receive information (e.g., position and orientation) related to a field of view of workers 10, determination of information related to the field of view, potential hazards and/or safety events, generation of indicator images having enhanced AR visualization and/or data for causing local generation of the indicator images by safety glasses 14, alert generation, or the like. Client applications executing on computing devices 32 may communicate with WSMS 6 to send and receive information that is retrieved, stored, generated, and/or otherwise processed by services 40. For example, the client applications may request and edit potential hazards or safety events, machine status, worker training, PPE compliance information, or any other information described herein including analytical data stored at and/or managed by WSMS 6. In some examples, client applications may request and display information generated by WSMS 6, such as an AR display including one or more indicator images. In addition, the client applications may interact with WSMS 6 to query for analytics information about PPE compliance, safety event information, audit information, or the like. The client applications may output for display information received from WSMS 6 to visualize such information for users of clients 30. As further illustrated and described below, WSMS 6 may provide information to the client applications, which the client applications output for display in user interfaces.

Client applications executing on computing devices 32 may be implemented for different platforms but include similar or the same functionality. For instance, a client application may be a desktop application compiled to run on a desktop operating system, such as Microsoft Windows, Apple OS X, or Linux, to name only a few examples. As another example, a client application may be a mobile application compiled to run on a mobile operating system, such as Google Android, Apple iOS, Microsoft Windows Mobile, or BlackBerry OS to name only a few examples. As another example, a client application may be a web application such as a web browser that displays web pages received from WSMS 6. In the example of a web application, WSMS 6 may receive requests from the web application (e.g., the web browser), process the requests, and send one or more responses back to the web application. In this way, the collection of web pages, the client-side processing web application, and the server-side processing performed by WSMS 6 collectively provides the functionality to perform techniques of this disclosure. In this way, client applications use various services of WSMS 6 in accordance with techniques of this disclosure, and the applications may operate within different computing environments (e.g., a desktop operating system, mobile operating system, web browser, or other processors or processing circuitry, to name only a few examples).

As shown in FIG. 2, in some examples, WSMS 6 includes an interface layer 36 that represents a set of application programming interfaces (API) or protocol interface presented and supported by WSMS 6. Interface layer 36 initially receives messages from any of clients 30 for further processing at WSMS 6. Interface layer 36 may therefore provide one or more interfaces that are available to client applications executing on clients 30. In some examples, the interfaces may be application programming interfaces (APIs) that are accessible over network 4. In some example approaches, interface layer 36 may be implemented with one or more web servers. The one or more web servers may receive incoming requests, may process, and/or may forward information from the requests to services 40, and may provide one or more responses, based on information received from services 40, to the client application that initially sent the request. In some examples, the one or more web servers that implement interface layer 36 may include a runtime environment to deploy program logic that provides the one or more interfaces. As further described below, each service may provide a group of one or more interfaces that are accessible via interface layer 36.

In some examples, interface layer 36 may provide Representational State Transfer (RESTful) interfaces that use HTTP methods to interact with services and manipulate resources of WSMS 6. In such examples, services 40 may generate JavaScript Object Notation (JSON) messages that interface layer 36 sends back to the client application that submitted the initial request. In some examples, interface layer 36 provides web services using Simple Object Access Protocol (SOAP) to process requests from client applications. In still other examples, interface layer 36 may use Remote Procedure Calls (RPC) to process requests from clients 30. Upon receiving a request from a client application to use one or more services 40, interface layer 36 sends the information to application layer 38, which includes services 40.

As shown in FIG. 2, WSMS 6 also includes an application layer 38 that represents a collection of services for implementing much of the underlying operations of WSMS 6. Application layer 38 receives information included in requests received from client applications that are forwarded by interface layer 36 and processes the information received according to one or more of services 40 invoked by the requests. Application layer 38 may be implemented as one or more discrete software services executing on one or more application servers, e.g., physical or virtual machines. That is, the application servers provide runtime environments for execution of services 40. In some examples, the functionality of interface layer 36 as described above and the functionality of application layer 38 may be implemented at the same server.

Application layer 38 may include one or more separate software services 40 (e.g., processes) that may communicate via, for example, a logical service bus 44. Service bus 44 generally represents a logical interconnection or set of interfaces that allows different services to send messages to other services, such as by a publish/subscription communication model. For example, each of services 40 may subscribe to specific types of messages based on criteria set for the respective service. When a service publishes a message of a particular type on service bus 44, other services that subscribe to messages of that type will receive the message. In this way, each of services 40 may communicate information to one another. As another example, services 40 may communicate in point-to-point fashion using sockets or other communication mechanism. Before describing the functionality of each of services 40, the layers are briefly described herein.

Data layer 46 of WSMS 6 represents a data repository 48 that provides persistence for information in WSMS 6 using one or more data repositories 48. A data repository, generally, may be any data structure or software that stores and/or manages data. Examples of data repositories include but are not limited to relational databases, multi-dimensional databases, maps, and/or hash tables. Data layer 46 may be implemented using Relational Database Management System (RDBMS) software to manage information in data repositories 48. The RDBMS software may manage one or more data repositories 48, which may be accessed using Structured Query Language (SQL). Information in the one or more databases may be stored, retrieved, and modified using the RDBMS software. In some examples, data layer 46 may be implemented using an Object Database Management System (ODBMS), Online Analytical Processing (OLAP) database, or any other suitable data management system.

As shown in FIG. 2, each of services 40A-40H is implemented in a modular form within WSMS 6. Although shown as separate modules for each service, in some examples the functionality of two or more services may be combined into a single module or component. Each of services 40 may be implemented in software, hardware, or a combination of hardware and software. Moreover, services 40 may be implemented as standalone devices, separate virtual machines or containers, processes, threads, or software instructions generally for execution on one or more physical processors or processing circuitry.

In some examples, one or more of services 40 may each provide one or more interfaces 42 that are exposed through interface layer 36. Accordingly, client applications of computing devices 32 may call one or more interfaces 42 of one or more of services 40 to perform techniques of this disclosure.

In some cases, services 40 include a field of view analyzer 40A used to identify a field of view of environment 8B a worker 10 is viewing through safety glasses 14. For example, field of view analyzer 40A may receive current pose information (position and orientation), images, a video, or other information representative of the field of view from a client 30, such as safety glasses 14, and may read information stored in landmark data repository 48A to identify the field of view. In some examples, landmark data repository 48A may represent a 3D map of positions and identifications of landmarks within the particular work environment. In some examples, this information can be used to identify where worker 10 may be looking within work environment 8B, such as by performing Simultaneous Localization and Mapping (SLAM) for vision-aided inertial navigation (VINS). For instance, landmark data repository 48A may include identifying features, location information, or the like relating to machines, equipment, workers 10, buildings, windows, doors, signs, or anything other components within work environment 8B that may be used to identify the field of view. In other examples, data from one or more global positioning sensors (GPS) and accelerometers may be sent to field of view analyzer 40 by safety glasses 14 for determining the position and orientation of the worker as the work traverses the work environment. In some examples, position and orientation tracking may be performed by vision and inertial data, GPS data, and/or combinations thereof, and may be performed locally by estimation components within safety glasses 14 and/or remotely by field of view analyzer 40A of WSMS 6.

In some examples, field of view analyzer 40A may use additional or alternative information, such as a location of worker 10, a job site within work environment 8B worker 10 is scheduled to work at, sensing data of other articles of PPE, or the like to identify the field of view of the worker 10. For example, in some cases, safety glasses 14 may include one or more components configured to determine a GPS location, direction or orientation, and/or elevation of safety glasses 14 to determine the field of view. In some such cases, landmark data repository 48A may include respective locations, directions or orientations, and/or elevations of components of work environment 8B, and may use the locations, directions or orientations, and/or elevations of the components to determine what is in the field of view of worker 10 based on GPS location, direction or orientation, and/or elevation of safety glasses 14.

In some examples, field of view analyzer 40A may process the received images, video, or other information representative of the field of view to include information in the same form as the landmark information stored in landmark data repository 48A. For example, field of view analyzer 40A may analyze an image or a video to extract data and/or information that is included in landmark data repository 48A. As one example, field of view analyzer 40A may extract data representative of specific machines and equipment within an image or video to compare to data stored in landmark data repository 48A.

In some examples, work environment 8B may include tags or other identification information throughout work environment 8B, and field of view analyzer 40A may extract such information from the received images, videos, and/or data to determine the field of view. For example, work environment 8B may include a plurality of quick response (QR) codes distributed throughout the work environment 8B, and field of view analyzer 40A may determine one or more QR codes within the received field of view and compare to corresponding QR codes stored in landmark data repository 48A to identify the field of view. In other examples, different tags or identifying information other than QR codes may by distributed throughout work environment 8B.

Field of view analyzer 40A may also be able to identify details about a worker 10, an article of PPE worn by a worker 10, a machine, or another aspect of the field of view. For example, field of view analyzer 40A may be able to identify a brand, a model, a size, or the like of an article of PPE worn by a worker 10 within the field of view. As another example, field of view analyzer 40A may be able to determine a machine status of a machine within the field of view. The identified details may be saved in at least one of landmark data repository 48A, safety data repository 48B, or worker data repository 48C, may be sent to information processor 40B, or both. Field of view analyzer 40A may further create, update, and/or delete information stored in landmark data 48A, safety data repository 48B, and/or worker data repository 48C.

Field of view analyzer 40A may also be able to detect and/or identify one or more gestures by worker 10 within the field of view. Such gestures may be performed by worker 10 for various reasons, such as, for example, to indicate information about the field of view to WSMS 6, adjust user settings, generate one or more indicator images, request additional information, or the like. For instance, worker 10 may perform a specific gesture to indicate the presence of a safety event within the field of view that may not be indicated with an indicator image. As another example, worker 10 may use a gesture in order to silence or turn-off one or more functions of the AR display, such as, one or more indicator images. Gesture inputs and corresponding functions of WSMS 6 and/or safety glasses may be stored in any of landmark data 48A, safety data repository 48B, and/or worker data repository 48C.

Field of view analyzer 40A may be configured to continuously identify the field of view of safety glasses 14. For example, field of view analyzer 40A may continuous determine fields of views as worker 10 is walking or moving through work environment 8B. In this way, WSMS 6 may continuously generate and update indicator images, AR displays, or other information that is provided to worker 10 via safety glasses 14 in real time or near real-time.

Information processor 40B determines information relating to the field of view determined by field of view analyzer 40A. For example, as described herein, information processor 40B may determine potential hazards, safety events, presence of workers 10, machine or equipment statuses, PPE information, location information, instructions, task lists, or other information relating to the field of view. For instance, information processor 40B may determine potential hazards and safety events within the field of view.

Information processor 40B may read such information from safety data repository 48B and/or worker data repository 48C. For example, safety data repository 48B may include data relating to recorded safety events, sensed environmental conditions, worker indicated hazards, machine or equipment statuses, emergency exit information, safe navigation paths, proper PPE use instructions, service life or condition of articles of PPE, horizon or ground level indicators, boundaries, hidden structure information, or the like. Worker data repository 48C may include identification information of workers 10, PPE required for workers 10, PPE required for various work environments 8, articles of PPE that workers 10 have been trained to use, information pertaining to various sizes of one or more articles of PPE for workers 10, locations of workers, paths workers 10 have followed, gestures or annotations input by workers 10, machine or equipment training of workers 10, location restrictions of workers 10, task lists for specific workers 10, PPE compliance information of workers 10, physiological information of workers 10, motions of workers 10, or the like. In some examples, information processor 40B may be configured to determine a severity, ranking, or priority of information within the field of view.

Information processor 40B may further create, update, and/or delete information stored in safety data repository 48B and/or worker data repository 48C. For example, information processor 40B may update worker data repository 48C after a worker 10 undergoes training for one or more articles of PPE, or information processor 40B may delete information in worker data repository 48C if a worker 10 has outdated training on one or more articles of PPE. As another example, information processor 40B may update or delete a safety event in safety data repository 48B upon detection or conclusion, respectively, of the safety event. In other examples, information processor 40B may create, update, and/or delete information stored in safety data repository 48B and/or in worker data repository 48C due to additional or alternative reasons.

Moreover, in some examples, such as in the example of FIG. 2, a safety manager may initially configure one or more rules pertaining to information that is relevant to a field of view. As such, remote user 24 may provide one or more user inputs at computing device 18 that configure a set of rules relating to field of views and/or work environment 8B. For example, computing device 32 of the safety manager may send a message that defines or specifies the one or more articles of PPE required for a specific job function, for a specific environment 8, for a specific worker 10A, or the like. As another example, computing device 32 of the safety manager may send a message that defines or specifies when certain information should be determined to pertain to the field of view. For instance, the message may define or specify a distance threshold that a worker 10 is from a safety event or potential hazard in which the safety event or potential hazard becomes relevant to the field of view. Such messages may include data to select or create conditions and actions of the rules. As yet another example, computing device 32 of the safety manager may send a message that defines or specifies severities, rankings, or priorities of different types of information relating to the field of view. WSMS 6 may receive the message at interface layer 36 which forwards the message to information processor 40B, which may additionally be configured to provide a user interface to specify conditions and actions of rules, receive, organize, store, and update rules included in safety data repository 48B and/or worker data repository 48C, such as rules indicating what information is relevant to a field of view in various cases.

In some examples, storing the rules may include associating a rule with context data, such that information processor 40B may perform a lookup to select rules associated with matching context data. Context data may include any data describing or characterizing the properties or operation of a worker, worker environment, article of PPE, or any other entity. In some examples, the context data (or a portion of context data) may be determined based on the field of view identified by field of view analyzer 40A. Context data of a worker may include, but is not limited to, a unique identifier of a worker, type of worker, role of worker, physiological or biometric properties of a worker, experience of a worker, training of a worker, time worked by a worker over a particular time interval, location of the worker, or any other data that describes or characterizes a worker. Context data of an article of PPE may include, but is not limited to, a unique identifier of the article of PPE; a type of PPE of the article of PPE; a usage time of the article of PPE over a particular time interval; a lifetime of the PPE; a component included within the article of PPE; a usage history across multiple users of the article of PPE; contaminants, hazards, or other physical conditions detected by the PPE, expiration date of the article of PPE; operating metrics of the article of PPE; size of the PPE; or any other data that describes or characterizes an article of PPE. Context data for a work environment may include, but is not limited to, a location of a work environment, a boundary or perimeter of a work environment, an area of a work environment, hazards within a work environment, physical conditions of a work environment, permits for a work environment, equipment within a work environment, owner of a work environment, responsible supervisor and/or safety manager for a work environment; or any other data that describes or characterizes a work environment.

In general, indicator image generator 40C operates to control display of enhanced AR information by AR display 13 of safety glasses 14. In one example, indicator image generator 40C generates one or more indicator images (overlay image data) related to the information relevant to the field of view as determined by information processor 40B and communicates the overlay images to safety glasses 14. In other examples, indicator image generator 40C communicates commands that cause safety glasses 14 to locally render an AR element on a region of the AR display. As one example implementation, indicator image generator 40C installs and maintains a database (e.g., a replica of all or a portion of AR display data 48D, described below) within safety glasses 14 and outputs commands specifying an identifier and a pixel location for each AR element to be rendered. Responsive to the commands, safety glasses 14 generates image data for presenting the enhanced AR information to the worker via AR display 13.

As examples, the one or more indicator images may include a symbol (e.g., a hazard sign, a check mark, an X, an exclamation point, an arrow, or another symbol), a list, a notification or alert, an information box, a status indicator, a path, a ranking or severity indicator, an outline, a horizon line, an instruction box, or the like. In any case, the indicator images may be configured to direct a worker's attention to or provide information about an object within the field of view or a portion of the field of view. For example, the indicator images may be configured to highlight a safety event, a potential hazard, a safe path, an emergency exit, a machine or piece of equipment, an article of PPE, PPE compliance of a worker, or any other information as described herein.

Indicator image generator 40C may read information from AR display data repository 48D to generate the indicator images or otherwise generate the commands for causing the display of the indicator images. For example, AR display data repository 48D may include previously stored indicator images, which may be understood as graphical elements also referred to herein as AR elements, and may store unique identifiers associated with each graphical element. Thus, indicator image generator 40C may be able to access a previously stored indicator image from AR display data repository 48D, which may enable indicator image generator 40C to generate the one or more indicator images using a previously stored indicator image and/or by modifying a previously stored indicator image. Additionally, or alternatively, indicator image generator 40C may render one or more new indicator images rather than using or modifying a previously stored indicator image.

In some examples, indicator image generator 40C may also generate, or cause to be generated, animated or dynamic indicator images. For example, indicator image generator 40C may generate flashing, color-changing, moving, or indicator images that are animated or dynamic in other ways. In some cases, a ranking, priority, or severity of information to be indicated by an indicator image may be factored into the generation of the indicator image. For instance, if information processor 40B determines a first safety event within the field of view is more severe than a second safety event within the field of view, indicator image generator 40C may generate a first indicator image that is configured to draw more attention to the first safety event than the indicator image for the second safety event (e.g., a flashing indicator image in comparison to a static indicator image).

Indicator image generator 40C may further create, update, and/or delete information stored in AR display data repository 48D. For example, indicator image generator 40C may update AR display data repository 48D to include one or more rendered or modified indicator images. In other examples, indicator image generator 40C may create, update, and/or delete information stored in AR display data repository 48D to include additional and/or alternative information.

In some examples, WSMS 6 includes an AR display generator 40D that generates the AR display. As described above, in other examples, all or at least a portion of the AR display may be generated locally by safety glasses 14 in response to commands from WSMS 6 in a manner similar to the examples described herein. In some examples, AR display generator 40D generates the AR display including at least the one or more indicator images generated by indicator image generator 40C. For example, AR display generator 40D may be configured to arrange the one or more indicator images in a configuration based on the determined field of view such that the one or more indicator images overlay and/or obscure the desired portion of the field of view. For example, AR display generator 40D may generate an AR display including an indicator image for a safety event in a specific location such that the indicator image is overlaid on the safety event within the field of view when presented to worker 10 via safety glasses 14. AR display generator 40D may additionally, or alternatively, obscure a portion of the view of view.

In some examples, AR display generator 40D may generate (or cause to be generated locally) a plurality of AR displays for the field of view. In some such cases, a worker 10 may be able to interact with one or more of the AR displays. For example, AR display generator 40D may generate an AR display that indicates a worker in the field of view is not properly equipped with PPE, and the worker 10 may be able to interact with the AR display (e.g., as seen through safety glasses 14) to request additional information about the worker not properly equipped with PPE. For instance, the worker 10 may be able to complete a gesture in the field of view that results in a second AR display being presented via safety glasses 14. The second display may include an information box as an indicator image to provide details with respect to the improper or missing PPE of the worker in the field of view. Thus, AR display generator 40D may generate both the first AR display that includes the indicator image signifying that the worker is not properly equipped with PPE and the second AR display that includes additional information relating the worker's PPE. As another example, AR display generator 40D may generate a first AR display including a task list, and one or more additional AR displays that include tasks marked off as indicated by a gesture of the worker within the field of view.

In some cases, AR display generator 40D may use information stored in AR display data repository 48D to generate the AR display (or cause the AR display to be generated locally by safety glasses 14). For example, AR display generator 40D may use or modify a stored arrangement of an AR display for a similar or the same field of view as determined by field of view analyzer 40A. Moreover, AR display generator 40D may further create, update, and/or delete information stored in AR display data repository 48D. For example, AR display generator 40D may update AR display data repository 48D to include arranged displays of one or more indicator images, alone or including a portion of the field of view. In other examples, AR display generator 40D may create, update, and/or delete information stored in AR display data repository 48D to include additional and/or alternative information.

AR display generator 40D may send the generated AR displays to safety glasses 14 for presentation. For example, AR display generator 40D may send an AR display including an arrangement of one or more indicator images to be overlaid on the field of view seen through safety glasses 14. As another example, AR display generator 40D may send a generated AR display including both the arranged indicator images and at least a portion of the field of view.

In some examples, analytics service 40F performs in depth processing of data streams from the PPEs, the field of view, identified relevant information, generated AR displays, or the like. Such in depth processing may enable analytics service 40F to determine PPE compliance of workers 10, presence of safety events or potential hazards, more accurately identify the fields of view, more accurately identify gestures of a worker, identify worker preferences, or the like.

As one example, PPEs and/or other components of the work environment may be fitted with electronic sensors that generate streams of data regarding status or operation of the PPE, environmental conditions within regions of the work environment, and the like. Analytics service 40F may be configured to detect conditions in the streams of data, such as by processing the streams of PPE data in accordance with one or more analytical models 48E. Based on the conditions detected by analytics service 40F and/or conditions reported or otherwise detected in a particular work environment, analytics service 40F may update AR display data 48D to include indicators to be displayed to individuals (e.g., workers of safety managers) within the work environment in real-time or pseudo real-time based on the particular location and orientation of the augmented reality display device associated with the individual. In this way, AR information displayed via safety glasses 14 may be controlled in real-time, closed-loop fashion in response to analytical processing of streams of data from PPEs and other sensors collocated with a particular work environment.

In some cases, analytics service 40F performs in depth processing in real-time to provide real-time alerting and/or reporting. In this way, analytics service 40F may be configured as an active worker safety management system that provides real-time alerting and reporting to a safety manager, a supervisor, or the like in the case of PPE non-compliance of a worker 10, a safety event or potential hazard, or the like. This may enable the safety manager and/or supervisor to intervene such that workers 10 are not at risk for harm, injury, health complications, or combinations thereof due to a lack of PPE compliance, a safety event or potential hazard, or the like.

In addition, analytics service 40F may include a decision support system that provides techniques for processing data to generate assertions in the form of statistics, conclusions, and/or recommendations. For example, analytics service 40F may apply historical data and/or models stored in models repository 48E to determine the accuracy of the field of view determined by field of view analyzer 40A, the relevant information determined by information processor 40B, the gestures determined by field of view analyzer 40A, and/or the AR displays generated by AR display generator 40D. In some such examples, analytics service 40F may calculate a confidence level relating to the accuracy of the field of view determined by field of view analyzer 40A, the relevant information determined by information processor 40B, the gestures determined by field of view analyzer 40A, and/or the AR displays generated by AR display generator 40D. As one example, in the case in which lighting conditions of work environment 8B may be reduced, the confidence level calculated by analytics service 40F for the identified field of view may be lower than a confidence level calculated when lighting conditions are not reduced. In some cases, if the calculated confidence level is less than or equal to a threshold confidence level, notification service 40E may present an alert (e.g., via safety glasses) to notify worker 10 that the results of the field of view identification may not be completely accurate. Hence, analytics service 40F may maintain or otherwise use one or more models that provide statistical assessments of the accuracy of the field of view determined by field of view analyzer 40A, the relevant information determined by information processor 40B, the gestures determined by field of view analyzer 40A, and/or the AR displays generated by AR display generator 40D. In one example approach, such models are stored in models repository 48E.

Analytics service 40F may also generate order sets, recommendations, and quality measures. In some examples, analytics service 40F may generate user interfaces based on processing information stored by WSMS 6 to provide actionable information to any of clients 30. For example, analytics service 40F may generate dashboards, alert notifications, reports, or the like for output at any of clients 30. Such information may provide various insights regarding baseline (“normal”) safety event occurrences, PPE compliance, worker productivity, or the like.

Moreover, analytics service 40F may use in depth process to more accurately identify the field of view, the relevant information related to the field of view, the gestures input by a worker, and/or the arrangement of indicator images for the AR displays. For example, although other technologies can be used, analytics service 40F may utilize machine learning when processing data in depth. That is, analytics service 40F may include executable code generated by application of machine learning to identification of the field of view, relevant information related to the field of view, gestures input by a worker, and/or the arrangement of indicator images for the AR displays, image analyzing, or the like. The executable code may take the form of software instructions or rule sets and is generally referred to as a model that can subsequently be applied to data generated by or received by WSMS 6 for detecting similar patterns, identifying the field of view, relevant information related to the field of view, gestures input by a worker, and/or the arrangement of indicator images for the AR displays, image analyzing, or the like.

Analytics service 40F may, in some examples, generate separate models for each worker 10, for a particular population of workers 10, for a particular work environment 8, for a particular field of view, for a specific type of safety event of hazard, for a machine and/or piece of equipment, for a specific job function, or for combinations thereof, and store the models in models repository 48E. Analytics service 40F may update the models based on data received from safety glasses 14, communication hubs 13, beacons 17, sensing stations 21, and/or any other component of WSMS 6, and may store the updated models in models repository 48E. Analytics service 40F may also update the models based on statistical analysis performed, such as the calculation of confidence intervals, and may store the updated models in models repository 48E.

Example machine learning techniques that may be employed to generate models can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms, or the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LUQ), Self-Organizing Map (SOM), Locally Weighted Learning (LWL), Ridge Regression, Least Absolute Shrinkage and Selection Operator (LASSO), Elastic Net, Least-Angle Regression (LARS), Principal Component Analysis (PCA), and/or Principal Component Regression (PCR).

Record management and reporting service 40G processes and responds to messages and queries received from computing devices 32 via interface layer 36. For example, record management and reporting service 40G may receive requests from client computing devices 32 for data related to individual workers, populations or sample sets of workers, and/or environments 8. In response, record management and reporting service 40G accesses information based on the request. Upon retrieving the data, record management and reporting service 40G constructs an output response to the client application that initially requested the information. In some examples, the data may be included in a document, such as an HTML document, or the data may be encoded in a JSON format or presented by a dashboard application executing on the requesting client computing device.

As additional examples, record management and reporting service 40G may receive requests to find, analyze, and correlate information over time. For instance, record management and reporting service 40G may receive a query request from a client application for safety events, potential hazards, worker-entered gestures, PPE compliance, machine status, or any other information described herein stored in data repositories 48 over a historical time frame, such that a user can view the information over a period of time and/or a computing device can analyze the information over the period of time.

In some examples, services 40 may also include security service 40H that authenticates and authorizes users and requests with WSMS 6. Specifically, security service 40H may receive authentication requests from client applications and/or other services 40 to access data in data layer 46 and/or perform processing in application layer 38. An authentication request may include credentials, such as a username and password. Security service 40H may query worker data repository 48C to determine whether the username and password combination is valid. Worker data repository 48C may include security data in the form of authorization credentials, policies, and any other information for controlling access to WSMS 6. Worker data repository 48C may include authorization credentials, such as combinations of valid usernames and passwords for authorized users of WSMS 6. Other credentials may include device identifiers or device profiles that are allowed to access WSMS 6.

Security service 40H may provide audit and logging functionality for operations performed at WSMS 6. For instance, security service 40H may log operations performed by services 40 and/or data accessed by services 40 in data layer 46. Security service 40H may store audit information such as logged operations, accessed data, and rule processing results in audit data repository 48F. In some examples, security service 40H may generate events in response to one or more rules being satisfied. Security service 40H may store data indicating the events in audit data repository 48F.

Although generally described herein as images, videos, gestures, landmarks, or any other stored information described herein as being stored in data repositories 48, in some examples, data repositories 48 may additionally or alternatively include data representing such images, videos, gestures, landmarks, or any other stored information described herein. As one example, encoded lists, vectors, or the like representing a previously stored indicator image and/or AR display may be stored in addition to, or as an alternative, the previously stored indicator image or AR display itself. In some examples, such data representing images, videos, gestures, landmarks, or any other stored information described herein may be simpler to store, evaluate, organize, categorize, or the like in comparison to storage of the actual images, videos, gestures, landmarks, or other information.

In general, while certain techniques or functions are described herein as being performed by certain components or modules, it should be understood that the techniques of this disclosure are not limited in this way. That is, certain techniques described herein may be performed by one or more of the components or modules of the described systems. Determinations regarding which components are responsible for performing techniques may be based, for example, on processing costs, financial costs, power consumption, or the like.

In general, while certain techniques or functions are described herein as being performed by certain components, e.g., WSMS 6, safety glasses 14, or communication hubs 13, it should be understood that the techniques of this disclosure are not limited in this way. That is, certain techniques described herein may be performed by one or more of the components of the described systems. For example, in some instances, safety glasses 14 may have a relatively limited sensor set and/or processing power. In such instances, one of communication hubs 13 and/or WSMS 6 may be responsible for most or all of the processing of data, identifying the field of view and relevant information, or the like. In other examples, safety glasses 14 and/or communication hubs 13 may have additional sensors, additional processing power, and/or additional memory, allowing for safety glasses 14 and/or communication hubs 13 to perform additional techniques. In other examples, other components of system 2 may be configured to perform any of the techniques described herein. For example, other articles of PPE, safety stations 15, beacons 17, sensing stations 21, communication hubs, a mobile device, another computing device, or the like may additionally or alternatively perform one or more of the techniques of the disclosure. Determinations regarding which components are responsible for performing techniques may be based, for example, on processing costs, financial costs, power consumption, or the like.

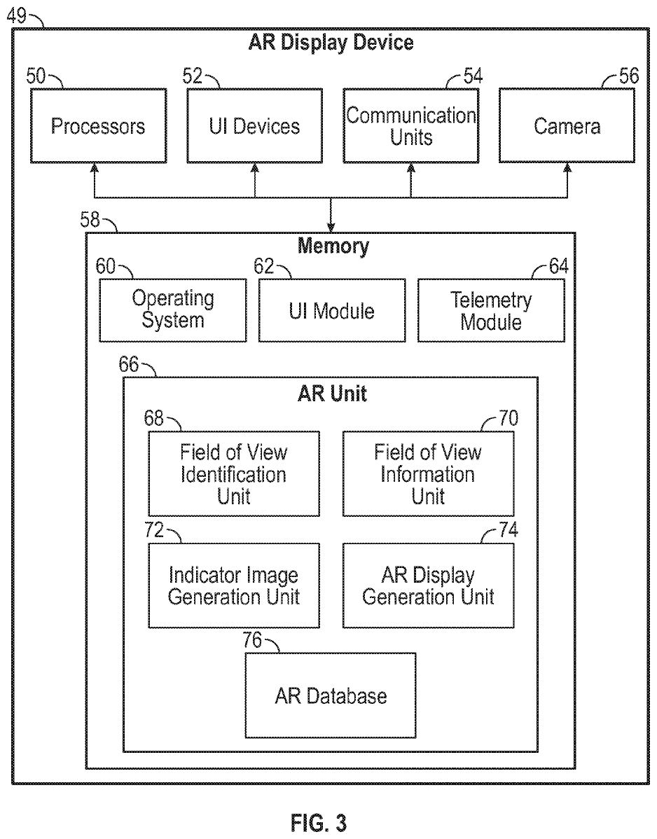

FIG. 3 is a block diagram illustrating an example an augmented reality display device 49 configured to present an AR display of a field of view of a work environment, in accordance with various techniques of this disclosure. The architecture of AR display device49 illustrated in FIG. 3 is shown for exemplary purposes only and AR display device 49 should not be limited to this architecture. In other examples, AR display device 49 may be configured in a variety of ways. In some examples, AR display device 49 may include safety glasses, such as safety glasses 14 of FIG. 1, a welding mask, a face shield, or another article of PPE.

As shown in the example of FIG. 3, AR display device 49 includes one or more processors 50, one or more user interface (UI) devices 52, one or more communication units 54, a camera 56, and one or more memory units 58. Memory 58 of AR display device 49 includes operating system 60, UI module 62, telemetry module 64, and AR unit 66, which are executable by processors 50. Each of the components, units, or modules of AR display device 49 are coupled (physically, communicatively, and/or operatively) using communication channels for inter-component communications. In some examples, the communication channels may include a system bus, a network connection, an inter-process communication data structure, or any other method for communicating data.

Processors 50, in one example, may include one or more processors that are configured to implement functionality and/or process instructions for execution within AR display device 49. For example, processors 50 may be capable of processing instructions stored by memory 58. Processors 50 may include, for example, microprocessors, DSPs, ASICs, FPGAs, or equivalent discrete or integrated logic circuitry, or a combination of any of the foregoing devices or circuitry.

Memory 58 may be configured to store information within AR display device 49 during operation. Memory 58 may include a computer-readable storage medium or computer-readable storage device. In some examples, memory 58 includes one or more of a short-term memory or a long-term memory. Memory 58 may include, for example, RAM, DRAM, SRAM, magnetic discs, optical discs, flash memories, or forms of EPROM, or EEPROM. In some examples, memory 58 is used to store program instructions for execution by processors 50. Memory 58 may be used by software or applications running on AR display device 49 (e.g., AR unit 66) to temporarily store information during program execution.

AR display device 49 may utilize communication units 54 to communicate with other systems, e.g., WSMS 6 of FIG. 1, via one or more networks or via wireless signals. Communication units 54 may be network interfaces, such as Ethernet interfaces, optical transceivers, radio frequency (RF) transceivers, or any other type of devices that can send and receive information. Other examples of interfaces may include Wi-Fi, NFC, or Bluetooth® radios.

UI devices 52 may be configured to operate as both input devices and output devices. For example, UI devices 52 may be configured to receive tactile, audio, or visual input from a user of AR display device 49. In addition to receiving input from a user, UI devices 52 may be configured to provide output to a user using tactile, audio, or video stimuli. For instance, UI devices 52 may include a display configured to present the AR display as described herein. The display may be arranged on AR display device 49 such that the user of AR display device 49 looks through the display to see the field of view. Thus, the display may be at least partially transparent. The display may also align with the user's eyes, such as, for example, as (or a part of) lenses of a pair of safety glasses (e.g., safety glasses 14 of FIG. 1). Other examples of UI devices 52 include any other type of device for detecting a command from a user, a sound card, a video graphics adapter card, or any other type of device for converting a signal into an appropriate form understandable to humans or machines.

Camera 56 may be configured to capture images, a video feed, or both of the field of view as seen by the user through AR display device 49. In some examples, camera 56 may be configured to capture the images and/or video feed continuously such that AR display device 49 can generate an AR display in real time or near real time. In some cases, camera 56 or an additional camera or sensor may be configured to track or identify a direction of a user's eyes. For example, camera 56 or the additional camera may be configured capture an image, video, or information representative of where the user may be looking through AR display device 49. Although described herein as a camera 56, in other examples, camera 56 may include any sensor capable of detecting the field of view of AR display device 49.

Operating system 60 controls the operation of components of AR display device 49. For example, operating system 60, in one example, facilitates the communication of UI module 62, telemetry module 64, and AR unit 66 with processors 50, UI devices 52, communication units 54, camera 56, and memory 58. UI module 62, telemetry module 64, and AR unit 66 may each include program instructions and/or data stored in memory 58 that are executable by processors 50. For example, AR unit 66 may include instructions that cause AR display device 49 to perform one or more of the techniques described herein.

UI module 62 may be software and/or hardware configured to interact with one or more UI devices 52. For example, UI module 62 may generate audio or tactile output, such as speech or haptic output, to be transmit to a user through one or more UI devices 52. In some examples, UI module 62 may process an input after receiving it from one of UI devices 52, or UI module 62 may process an output prior to sending it to one of UI devices 52.

Telemetry module 62 may be software and/or hardware configured to interact with one or more communication units 54. Telemetry module 62 may generate and/or process data packets sent or received using communication units 54. In some examples, telemetry module 64 may process one or more data packets after receiving it from one of communication units 54. In other examples, telemetry module 64 may generate one or more data packets or process one or more data packets prior sending it via communication units 54.

In the example illustrated in FIG. 3, AR unit 66 includes field of view identification unit 68, field of view information unit 70, indicator image generation unit 72, AR display generation unit 74, and AR database 76. Field of view identification unit 68 may be the same or substantially the same as field of view analyzer 40A of FIG. 2; field of view information unit 70 may be the same or substantially the same as information processor 40B of FIG. 2; indicator image generation unit 72 may be the same of substantially the same as indicator image generator 40C of FIG. 2; AR display generation unit 74 may be the same or substantially the same as AR display generator 40D of FIG. 2; and AR database 76 may include contents similar to any one or more data repositories 48 of FIG. 2. Thus, the descriptions of functionalities of field of view identification unit 68, field of view information unit 70, indicator image generation unit 72, AR display generation unit 74, and AR database 76 will not be repeated herein. In some examples, field of view identification unit 68 may, as described above, apply localization to determine position an orientation using one or more accelerometers, image data from camera 56, GPS sensors, or combinations thereof, and may communicate the information to WSMS 6.

AR display device 49 may include additional components that, for clarity, are not shown in FIG. 3. For example, AR display device 49 may include a battery to provide power to the components of AR display device 49. Similarly, the components of AR display device 49 shown in FIG. 3 may not be necessary in every example of AR display device 49. For example, in some cases, WSMS 6, communication hubs 13, a mobile device, another computing device, or the like may perform some or all of the techniques attributed to AR unit 66, and thus, in some such examples, AR display device 49 may not include AR unit 66.

FIG. 4 is a conceptual diagram illustrating an example AR display 80 presented via AR display device 49 that includes a field of view 82 as seen through AR display device 49 and indicator images 84a, 84b designating a safety event 86 and a potential hazard 88, in accordance with various techniques of this disclosure. Worker 10 may be within a work environment (e.g., work environment 8B of FIG. 1) and wearing one or more articles of PPE including AR display device 49. In some examples, AR display device 49 may include safety glasses, such as safety glasses 14 of FIG. 1, a welding mask, a face shield, or another article of PPE.

Worker 10 may see a specific field of view 82 of work environment 8B through AR display device 49. For example, in the example illustrated in FIG. 4, field of view 82 includes a gas cylinder and a fork lift. In some examples, objects such as the gas cylinder and the fork lift may be used to identify field of view 82 (e.g., by field of view analyzer 40A of WSMS 6 of FIG. 2). In some examples, field of view 82 may include what worker 10 sees of the real work environment 8B (e.g., not including any augmented or computer-generated indicator images 84a, 84b). In other examples, one or more indicator images 84a, 84b may be considered part of field of view 82.

AR display 80 includes field of view 82 and indicator images 84a, 84b. In the example of FIG. 4, AR display 80 is configured to draw attention of worker 10 to both a safety event (e.g., a gas leak) 86 and a potential hazard (e.g., a moving fork lift) 88 using indicator images 84a, 84b. Indicator images 84a, 84b may be augmented or otherwise computer-generated images (e.g., generated by indicator image generator 40C of WSMS 6) and overlaid on field of view 82. In this way, indicator images 84a, 84b may draw the attention of or notify worker 10 of the actual locations of safety event 86 and potential hazard 88 within field of view 82. In turn, worker 10 may be able to actively avoid safety event 86 and potential hazard 88 to prevent harm or injury to himself or herself. In some examples, indicator images 84a, 84b may be used to draw the attention of worker 10 to noise-, respiratory-, heat-, sound level-, fall-, and/or eye-related hazards or safety events within field of view 82.

In some cases, indicator images 84a, 84b may alert worker 10 of safety events 86 and/or hazards 88 within field of view 82 that worker 10 may otherwise not be aware of. For example, safety event 86 including a gas leak may be a gas leak of a colorless and odorless gas in some cases. Thus, in some such instances, worker 10 may not realize the presence of the gas leak and may approach that area within field of view 82, which may result in health complications and/or injury. With the use of AR display device 49 configured to present AR display 80, however, worker 10 may be notified of safety event 86 even if the gas leakage includes a colorless and odorless gas.

Indicator images 84a, 84b are illustrated in FIG. 4 as hazard symbols. In other examples, indicator images 84a, 84b may be a variety of symbols, shapes, or other indicator images. Moreover, in some examples, indicator images 84a, 84b may be different symbols, shapes, colors, or the like from each other. For instance, in some examples, indicator images 84a, 84b may be presented based on a ranking, priority, and/or severity of safety event 86 and/or hazard 88. For example, in the example of FIG. 4, safety event 86 may have been designated has a more severe event than potential hazard 88. Thus, indicator image 84a may be configured to indicate the higher relative severity. For example, indicator image 84a may be red, relatively large, and flashing, whereas indicator image 84b may be yellow, relatively small, and static. In this way, worker 10 may be able to quickly discern the relative severities, priorities, and/or rankings of the indicated safety events 86 and potential hazards 88 within AR display 80. In some cases, such relative severities, priorities, and/or rankings may be determined based on context data, such as the context data described with respect to FIG. 2. As one example, the relative severities, priorities, and/or rankings may be determined based on nearby workers, other hazards within work environment 8B, vitals of worker 10 or other workers, status of one or more articles of PPE, or combinations thereof.

In some examples, AR display device 49 (or another component such as WSMS 6) may be configured to determine where worker 10 is looking. For example, AR display device 49 may be configured to determine if the worker's eyes are directed to at least one of safety event 86 or potential hazard 88. In some cases, if worker 10 is not looking at at least one of safety event 86 or potential hazard 88, AR display device 49 may output one or more additional or alternative image indicators 84a, 84b. For example, if worker 10 is looking at the bottom of field of view 82 rather than at at least one of safety event 86 or potential hazard 88, AR display 80 may present another indicator image at the bottom of field of view 82 alerting worker 10 to pay attention to safety event 86 or potential hazard 88. As another example, AR display 80 may present a different indicator image 84a, 84b that may be more captivating, such as, for example, a more brightly colored indicator image 84a, 84b, an animated indicator image 84a, 84b, a larger indicator image 84a, 84b, or the like. In turn, the worker's eyes may be directed toward safety event 86 or potential hazard 88, which may prevent worker 10 from accidently coming into contact with safety event 86 or potential hazard 88.

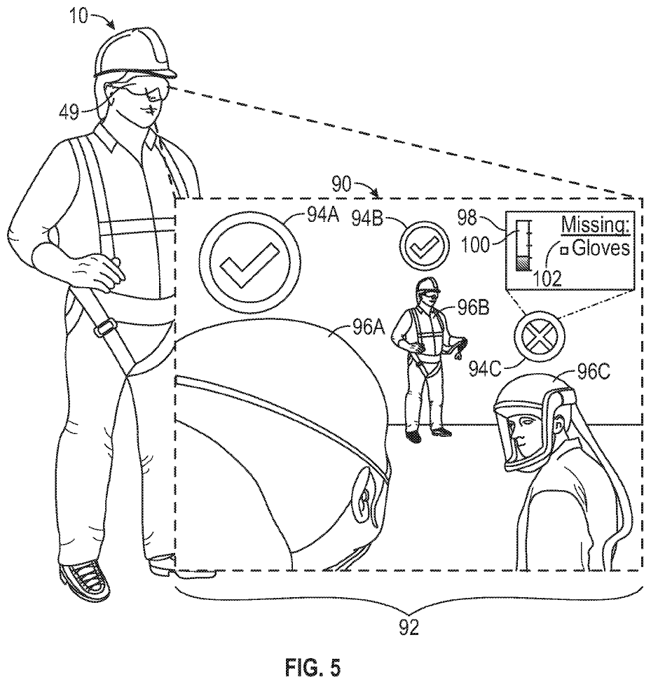

FIG. 5 is a conceptual diagram illustrating another example AR display 90 presented via AR display device 49 that includes a field of view 92 as seen through AR display device 49 and indicator images 94a-94c designating PPE compliance of workers 96a-96c, in accordance with various techniques of this disclosure. In the example of FIG. 5, worker 10 may be a supervisor or safety manager that is using AR display 90 to determine information, such as PPE compliance information of workers 96a-96c within the field of view 92. In some examples, AR display device 49 may include safety glasses, such as safety glasses 14 of FIG. 1, a welding mask, a face shield, or another article of PPE.

In field of view 92, three workers 96a-96c are seen. AR display 90 includes each worker 96a-96c within field of view 92 and an indicator image 94a-94c relating to the PPE compliance of the respective worker 96a-96c. For example, workers 96a and 96b each have indicator images 94a and 94b indicating proper PPE compliance (e.g., check marks) and worker 96c has an indicator image 94c indicating PPE non-compliance (e.g., X-mark). In this way, AR display 90 enables worker 10 to quickly and easily determine if workers 96a-96c are complying with PPE regulations. In cases in which one or more workers are not complying with PPE regulations, such as worker 96c in the example of FIG. 5, worker 10 may be able to intervene so that worker 96c is properly protected within the work environment.

In some examples, determination of PPE compliance of workers 96a-96c may be based on rules and/or context data as described herein. For instance, the PPE compliance may be determined using information such as environmental information, machines or equipment within the work environment, training of workers 96a-96c, job function of workers 96a-96c, motion information of workers 96a-96c, physiological information of workers 96a-96c, or the like.

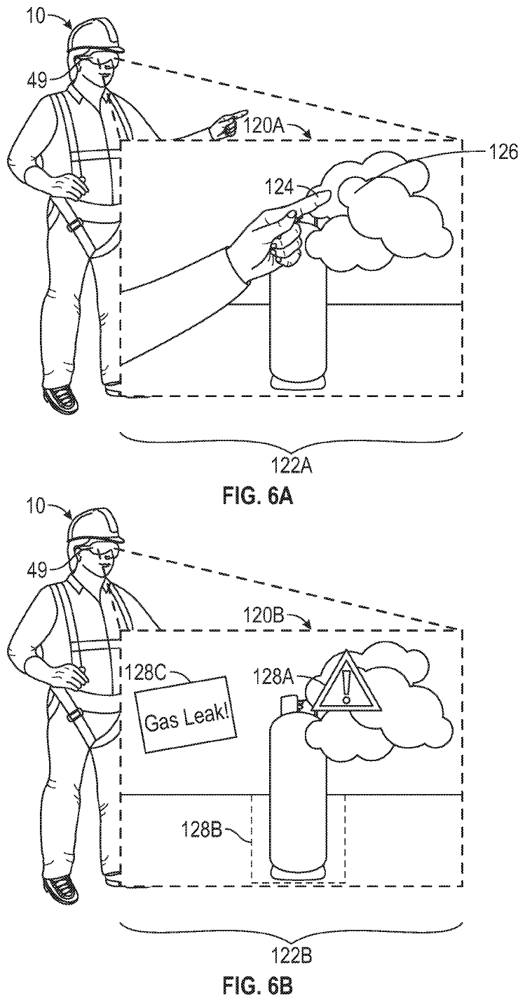

In some cases, worker 10 may be able to use AR display 90 to obtain additional information relating to workers 96a-96c or other portions of field of view 92. For instance, worker 10 may be able to use a gesture input within field of view 92 near workers 96a-96c and/or indicator images 94a-94c to be presented with additional information. In the example of FIG. 5, worker 10 may have used a gesture input within field of view 92 to open information box 98 including additional information relating to worker 96c. Examples of gesture inputs within the field of view of AR display device 49 will be described in more detail with respect to FIGS. 6A-6B.

Information box 98 may include a variety of information. As one example, information box 98 includes information relating to PPE non-compliance of worker 96c. For instance, information box 98 includes indicator image 102 signifying that worker 96c is missing gloves (e.g., an article of PPE). Information box 98 also includes an indicator image 100 indicating remaining service life of an article of PPE of worker 96c. In this way, AR display 90 may indicate service life, maintenance requirements, damage, diagnostic information, or the like of PPE in addition to, or as an alternative to, PPE non-compliance of workers 96a-96c. In the example of FIG. 5, indicator image 100 may signify that one or more articles of PPE may need maintenance, may be reaching the end of service life, may be damaged, or the like. Thus, negative indicator image 94c for worker 96c may be present due to PPE non-compliance of worker 96a (e.g., missing gloves) and/or due to the potentially reduced protection of one or more articles of PPE as indicated by indicator image 100.

Additionally, or alternatively, one or more indicator images of AR display 90 may show whether a worker has performed appropriate inspections on one or more articles of PPE, if a self-retracting lifeline (SRL) impact indicator is visible (e.g., determined using machine vision), if workers 96a-96c are properly trained to use one or more articles of PPE, if workers 96a-96c are qualified to use various pieces of machinery, one or more articles of PPE assigned to workers 96a-96c, provide crowd-sense data about workers 96a-96c, provide statistical information (e.g., aggregates, minimums, maximums, means, medians, standard deviations, etc.) about workers 96a-96c, compare workers 96a-96c (e.g., to each other, a larger population of workers, statistical information, etc.), or the like.

Moreover, indicator images 94a-94c, 98, 100, 102 may be presented in any suitable form. For example, service life indicator image 100 is illustrated in the example of FIG. 5 as a status bar. In other examples, indicator image 100 may additionally, or alternatively, be presented in AR display 90 as a percentage, a colored image indicator, or any other suitable indicator image. In some cases, AR display 90 may also be configured to indicate information relating to service life, PPE status, PPE compliance, or the like of the PPE of worker 10 himself in addition to, or as alternative to, presenting information relating to the PPE of workers 96a-96c alone.

In some examples, AR display device 49 (or WSMS 6) may be in communication with one or more additional articles of PPE. For example, AR display device 49 (or WSMS 6) may be communicatively coupled to ear muffs, a helmet, or another article of PPE that may be able to output audible information to worker 10. In some such cases, information included in AR display 90 may also be presented to worker 10 using an audible output (e.g., via the ear muffs or helmet). As another example, AR display device 49 (or WSMS 6) may be communicatively coupled to an article of PPE including a microphone or another input device. In some such examples, the microphone or other input device may be able to determine information about sound hazards, generate a sound map, present indicator images representative of sound levels, indicate sources of sound, or the like, and present such information via AR display 90. In some examples, such information may help determine if workers 96a-96c within field of view 92 are able to hear worker 10. Additionally, or alternatively, machine vision, GPS and/or location information, or the like may be used to help determine if workers 96a-96c are able to hear worker 10. Such information may be presented via AR display 90.

FIG. 6A is a conceptual diagram illustrating yet another AR display 120a in which worker 10 is performing a gesture input 124, in accordance with various techniques of this disclosure. FIG. 6B is a conceptual diagram illustrating an example AR display 120b after a plurality of indicator images 108 have been placed within field of view 122b using gesture inputs 124, in accordance with various techniques of this disclosure. In some examples, AR display device 49 may include safety glasses, such as safety glasses 14 of FIG. 1, a welding mask, a face shield, or another article of PPE. In some examples, AR display 120a, 120b may be interactive and enable worker 10 to use gesture inputs, speech inputs, or other inputs to annotate, add indicator images, or otherwise add additional or alternative information to AR display 120a, 120b.

In the example of FIG. 6A, worker 10 may see a safety hazard 126 (e.g., a gas leak) that is not indicated in field of view 122a. For instance, in field of view 122a of FIG. 6a, safety hazard 126 does not include an indicator image or any other information to alert worker 10 of the potentially dangerous situation. AR display 120a may enable worker 10 to use gesture inputs to add indicator images to alert other workers and/or WSMS 6 of safety event 126. Gesture inputs may include any type of gesture by worker 10. For example, specific hand and/or finger configurations, different lengths of gestures, interaction of two hands of worker 10, movements of hands and/or fingers of worker 10, or the like may be used to designate a specific gesture input. In the example of FIG. 6A, worker 10 is using a pointed finger gesture 124 near safety event 126 within field of view 122a.

AR display 120b may be the AR display presented by AR display device 49 after gesture input 124 by worker 10. For example, the pointed finger gesture 124 illustrated in FIG. 6A may result in placement of indicator image 128a including a hazard symbol near safety event 126. Worker 10 may have input additional gestures to add indicator images 128b and 128c to provide additional alerts regarding safety event 126. For instance, indicator image 128b includes a boundary drawn by worker 10 using a gesture input, and indicator image 128c includes an annotation written by worker 10 using a gesture input. Indicator images 128a-128c added to display 120b may be communicated to WSPS 6 for storage, analyzing, report generating, or the like. Thus, WSPS 6 may be able to generate subsequent AR displays with indicator images 128a-128c provided to WSPS 6 through the input gestures 124 of worker 10, such as AR displays for workers other than worker 10, that include safety event 126 within a field of view. Additionally, or alternatively, worker 10 may be able to share or push the added information or indicator images 128a-128c to other workers within the work environment. For example, the information or indicator images 128a-128c may be presented as a notification on AR displays of the AR display devices 49 of the other workers.

Similar to other indicator images described herein, WSPS 6, worker 10, another worker, sensors, beacons, or the like may be able to add additional information relating to safety event 126. For example, indicator image 128a may be able to be selected using a gesture input, which may open an information box or otherwise provide additional or alternative information via AR display 120b from WSPS 6, worker 10, another worker, sensors, beacons, or the like.

Although described with respect to safety event 124, gesture inputs may be able to be used for a wide range of scenarios or preform multiple different functions. For example, a gesture input may be used to open information box 98 of FIG. 5. Moreover, gesture inputs may be used add additional or alternative information relating to a field of view in general, another worker, a machine, a potential hazard, an article of PPE, or the like. Moreover, the information added by worker 10 using gesture input 124 may include any suitable information, such as, for example, presence of a safety event or potential hazard, notes about an indicator image or a portion of field of view 122a, 122b, a severity, priority, and/or rank, whether inspection is required, an update to previously added information or indicator image, a status, or the like.

In some cases, a gesture input may be used to configure one or more user settings of AR display device 49. For example, worker 10 may perform a gesture input 124 to silence indicator images 128a-128c on AR display 120b, only present certain indicator images 128a-128c, adjust the colors, sizes, animation, or other parameters of the indicator images, or the like. In some such cases, one or more settings may not be able to be modified by worker 10. For example, worker 10 may not be able to silence indicator images relating to a current safety event within a field of view or within a certain distance from worker 10.

In addition to, or as an alternative to, gesture inputs 124, worker 10 may be able to use inputs other than gesture inputs to add information to AR display 120a, 120b. For example, speech input, such as speech-to-text input, may be used to add information to AR display 120a, 120b. In other examples, other input methods may be used.

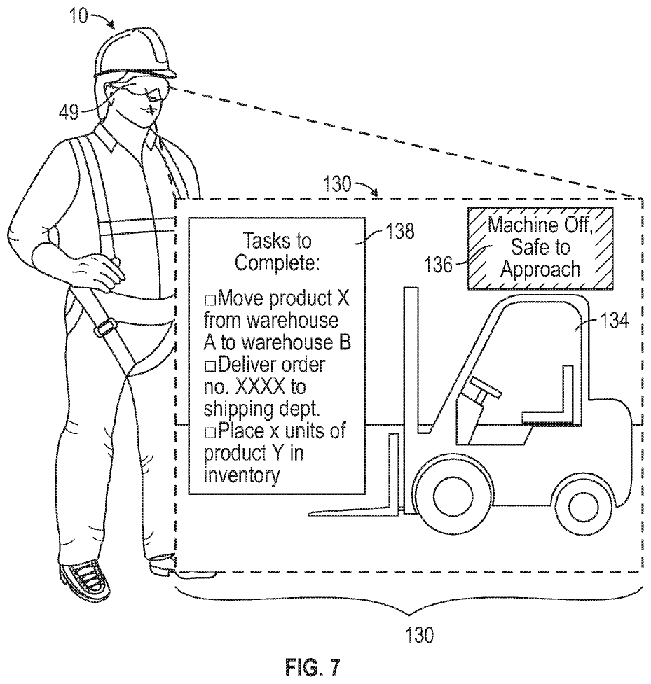

FIG. 7 is a conceptual diagram illustrating yet another example AR display 130 presented via AR display device 49 that includes a field of view 132 as seen through AR display device 49 and indicator images 136, 138 providing information relating to machine 134, in accordance with various techniques of the disclosure. In the example of FIG. 7, machine 134 includes a fork lift. In other examples, machine 134 may include a different type of machine and/or a plurality of machines. In some examples, AR display device 49 may include safety glasses, such as safety glasses 14 of FIG. 1, a welding mask, a face shield, or another article of PPE.

AR display 130 may include indicator image 136 configured to provide information relating to machine 134. For example, indicator image 136 includes a status of machine 134 (e.g., “machine off”) and whether machine 134 is safe to approach (e.g., “safe to approach”). In some examples, indicator image 134 may be based on context data in addition to information about machine 134 alone. For instance, whether worker 10 is allowed in an area of the work environment in which machine 134 is located, if worker 10 is trained to use machine 134, if worker 10 is equipped with the proper PPE to operate machine 134, if any safety events or potential hazards exist in the vicinity of machine 134, information relating to machines other than machine 134, information of other workers within the work environment, or any other information may be used to generate indicator image 136.

Additionally, or alternatively, AR display 130 may present indicator image 138 including a task list for worker 10. For example, worker 10 may use machine 134 to complete a plurality of tasks as presented by indicator image 138. Indicator image 138 may also enable worker 10 to check off tasks as the tasks are completed, such as by using a gesture input. Thus, indicator image 138 including a task list may help keep worker 10 productive and on task, help prevent worker 10 from failing to complete one or more tasks, and allow worker 10 to keep track of completed tasks.

In some examples, an indicator image including a task list may be used for PPE compliance, to enter a work environment or area of a work environment, or the like. For example, a worker that is scheduled to work in a fall risk environment or a confined space environment may have to check off each article of PPE required for the specific environment on an indicator image including a list of required PPEs prior to entering the specific environment. In other examples, indicator images including a task list, a list of required PPEs, or any other type of list may be based on different rule sets, such as rule sets defined by a supervisor or safety manager.

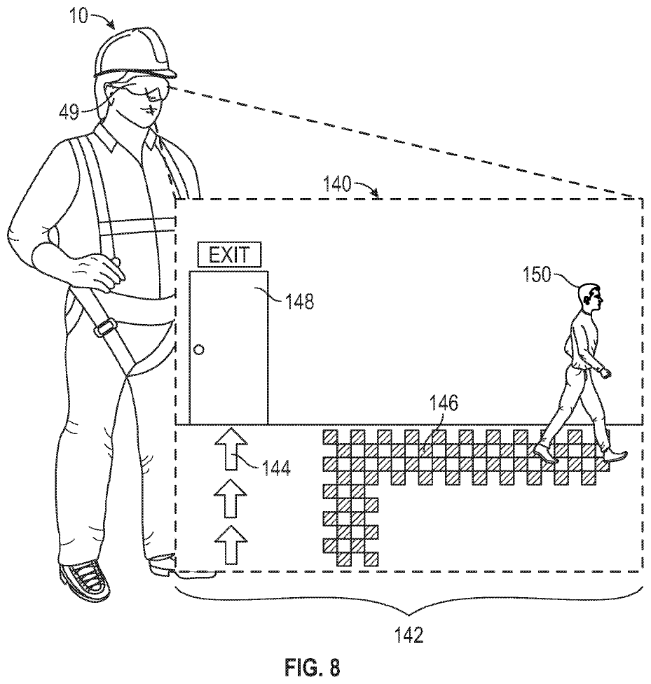

FIG. 8 is a conceptual diagram illustrating yet another example AR display 140 presented via AR display device 49 that includes a field of view 142 as seen through AR display device 49 and indicator images 144, 146 designating paths through field of view 142, in accordance with various techniques of the disclosure. In some examples, AR display device 49 may include safety glasses, such as safety glasses 14 of FIG. 1, a welding mask, a face shield, or another article of PPE.

In some examples, AR display 140 may be configured to designate one or more paths through field of view 142. As one example, indicator image 144 of FIG. 8 designates a path through field of view 142 toward an emergency exit 148. In this way, in an emergency situation, worker 10 may be able to follow the path illustrated by indicator image 144 that provides a safe path to emergency exit 148. In some cases, indicator image 144 illustrating a path to emergency exit 148 may be pushed to AR display device 49 of workers within a work environment during an emergency situation to help the workers safely exit the work environment. Indicator image 144 may also generally inform worker 10 of a location of one or more emergency exits 148 within field of view 142 or a work environment.

As another example, indicator image 146 may designate a path of another worker 150. In some examples, worker 10 may be following worker 150, and indicator image 146 may provide a “breadcrumb” path illustrating where worker 150 is walking. In some cases, AR display 140 may present an identity of worker 150, a direction in which worker 150 is walking, a distance from worker 150, a distance to a destination, a distance from one or more objects within field of view 142, or the like. In other examples, illustrated paths of other workers 150 similar to indicator image 146 may help worker 10 follow a relatively safe path through field of view 142. For instance, worker 150 may remain within designated paths throughout work environment, or indicator image 146 itself may only highlight paths that are determined to be safe.

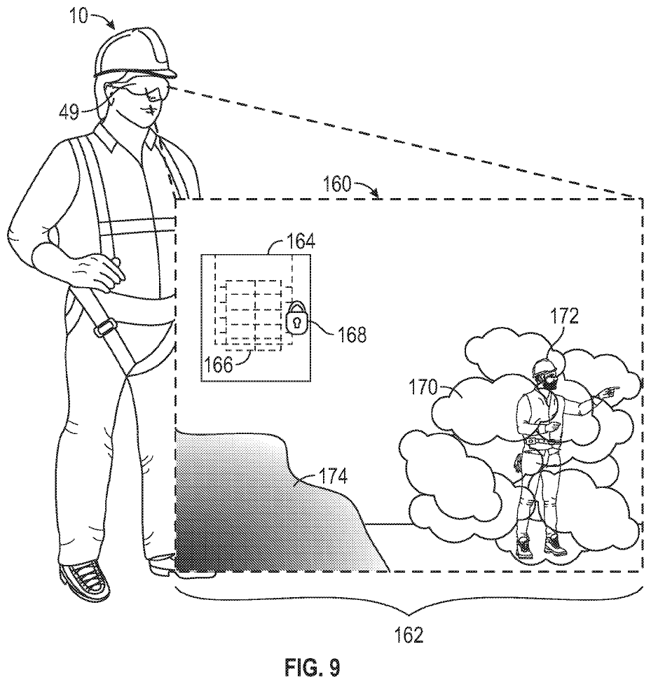

FIG. 9 is a conceptual diagram illustrating yet another example AR display 160 presented via AR display device 49 that includes a field of view 162 as seen through AR display device 49 and indicator images 166, 172 configured to provide additional information about low-visibility or non-visible aspects of field of view 162 and indicator image 174 configured to obscure a portion of field of view 162, in accordance with various techniques of the disclosure. In some examples, AR display device 49 may include safety glasses, such as safety glasses 14 of FIG. 1, a welding mask, a face shield, or another article of PPE.

In some examples, worker 10 may not be able to see one or more portions of field of view 162 that may be helpful for worker 10 to see. For example, a breaker box 164 may be non-transparent, and thus, worker 10 may not know what is behind breaker box 164 without opening it. In some cases, AR display 160 may present indicator image 166 illustrating “x-ray vision” that may include details about one or more portions of field of view 162 that worker 10 does not have immediate access to or that worker 10 cannot see, such as breaker box 164. In this way, AR display 160 may enable worker 10 to determine if breaker box 164 needs to be opened prior to opening it to see what its contents are. Additionally, or alternatively, indicator images may indicate contents behind a wall, a piece of equipment, a panel, a guard, or the like. Indicator image 166 configured to provide additional information about non-transparent object may include an image, a schematic (e.g., as shown in FIG. 9), or otherwise provide additional details to worker 10.

Indicator images may also be configured to provide instructions, sequence information, indicate that an action should be taken, or the like. For instance, AR display 160 may present an indicator image that instructs worker 10 that a lock 168 needs to be unlocked to open breaker box 164. The indicator image relating to lock 168 may additionally or alternatively provide information about a sequence of actions to take to unlock lock 168, where to find a key for lock 168, or the like. As one example, an indicator image may designate that lock 168 needs to be unlocked, and then, once unlocked, AR display 160 may present another indicator image directing worker 10 to a clasp (not shown) to be unlatched to open breaker box 164. In some such examples, the indicator images may include numbered steps. For example, unlocking lock 168 may be indicated as step number one, unlatching the clasp may be indicated as step number two, and opening breaker box 164 may be indicated as step number 3. Such numbered steps may be dynamically displayed via AR display 60 as worker 10 moves through the respective steps.

In some examples, AR display 160 may be configured to help worker 10 gain insight about his or her surroundings during a low-visibility situation. For example, if smoke 170, dust, fog, low-lighting or another low-visibility situation is within field of view 162, AR display 160 may present indicator images of other workers 172, a machine, walls, doors, windows, potential hazards, such as an area of high heat, or the like behind smoke 170 that worker 10 may not otherwise be able to see. In some cases, the indicator images 172 may be based on context data as described herein. Moreover, in some examples, AR display 160 may display at least some of the context data using an indicator image. For instance, AR display 160 may present indicator images noting environmental conditions of the low-visibility situation, health information of worker 172, or the like.

In addition to, or as an alternative to, providing additional information about low-visibility or non-visible aspects of field of view 162, an indicator image 174 may be configured to obscure a portion of field of view 162. In some examples, a portion of field of view 162 may be considered distracting (e.g., motion, other workers, objects, etc.), and AR display 160 may include indicator image 174 to obscure, block out, and/or remove the distracting portion of field of view 162 from field of view 162. In this way, indicator image 174 may help worker 10 focus on a particular task, prevent a safety event (e.g., due to worker 10 being distracted), increase productivity of worker 10, or combinations thereof.

As a further example, indicator images may present helpful information to a worker in a fall protection environment. For example, a worker may be performing a task on a sloped or angled surface, and may become disoriented with respect to the true horizon of the work environment. In some such examples, an AR display may be configured to present an indicator image that designates the true horizon of the work environment relative to the worker's field of view through AR display device 49. In turn, the worker may be able to better remain oriented with respect to the true horizon of the work environment while working on sloped or angled surfaces.

Moreover, a worker in a fall protection environment may be equipped with one or more articles of fall protection equipment. In some such examples, an AR display for the worker equipped with the fall protection gear may present one or more indicator images illustrating anchor points that are attached to the fall protection gear within the worker's field of view.

In some examples, a worker may be using tools within a field of view. In some such examples, an AR display may be configured to provide use instructions, determine if the worker is trained to use the tool, determine if the worker is equipped with the proper PPE to use the tool, determine if the worker is using a safe posture while using the tool, or the like. As one example, a worker may be using a power tool with one hand in the field of view. AR display (or WSPS 6) may determine that the worker is using an unsafe posture (e.g., should be holding the power tool with two hands). In some examples, context data such as machine vision, sensors, input from other workers, or any other context data described herein may be used to determine if the worker is properly using the tool. Then, the AR display may present one or more indicator images instructing the worker to the correct posture. For example, the AR display may present an indicator image of an outline of a second hand on the power tool, an arrow, and/or an annotation or information box directing the worker to correct his or her posture.

As an additional example of a use of an AR display on an article of PPE as described herein, the AR display may be able to identify sets of PPEs and determine if all sets of PPEs within an inventory are present. For instance, a field of view captured by a pair of safety glasses configured to present the AR display, along with context data (e.g., machine vision, RFID information, proximity detection, etc.) in some cases, may be used to determine if all sets of PPEs that should have been returned to a designated area have indeed been returned. For example, a supervisor or safety manager may be able to look around the designated area, such as an equipment locker that has sets of PPEs for multiple workers, to determine if all the sets of PPEs for the workers are present. If one or more sets of PPEs are not present, the AR display may present an indicator image indicating which sets of PPEs are missing. The indicator images for this example may include text or information stating, for example, “9 out of 10 sets of PPEs have been returned,” or “Bob Smith's set of PPEs is missing.” In this way, the supervisor or safety manager may be able to determine if the worker using the set of PPEs is also missing, if the sets of PPEs have stolen, or the like.

In some examples, the articles, systems, and techniques described herein may be used to help mitigate pain of a user (e.g., a worker). For example, in some cases, a worker experiencing pain may use an AR display, or a virtual reality (VR) display, in accordance with the techniques of the disclosure to help relieve pain. In some examples, the AR or VR display may be able to be adjusted based on objective pain measurements. In this way, the AR or VR display may be suited for the particular worker, determine parameters of the display that are effective in mitigating pain in specific workers, a population of workers, for workers having a certain injury or type of pain, or the like. As one example, a worker experiencing pain from a burn may feel relief from the pain when viewing an AR or VR display of a snow world, an underwater world, or the like.

In some cases, objective physiological measurements from a worker may be measured to compute a pain score, which may be used to determine an effectiveness of the AR or VR display presented to the worker. The objective physiological measurements may include a skin temperature, a galvanic skin response, a cortisol level, a muscle tension, a blood pressure, a heart rate, an electroencephalograph measurement, a depth of breathing, a frequency of breathing, and/or pupil dilation. Such objective physiological measurements may be measured using one or more of an infrared thermometer, a capacitance measurement, a blood test, a gripping pressure, a heart rate monitor, a blood pressure monitor, an electroencephalograph, carbon dioxide expulsion, chest measurements, a camera image or video, or any other measurement techniques. In some examples, the measurements may be time-stamped. The measurements may be taken periodically or continuously.

In some examples, one or more parameters of the AR or VR display may be adjusted as the objective physiological measurements are taken to determine which parameters are relatively more effective than others. For example, one or more parameters of the display may be adjusted overtime, and a pain score may be computed for each parameter or combination of parameters. The pain score may include a linear or non-linear combination of the objective physiological measurements of the worker.

In some cases, the pain score may be based on the objective physiological measurements and the time-stamp at which the measurements were taken. For instance, the time-stamp may be used to time-shift the objective physiological measurements based on a relationship between worker pain and response to the pain indicated in the one or more objective physiological measurements. In some examples, the pain score may also be based on subjective questioning of the worker (e.g., the worker's own determination of pain). The pain scores may be compared to baseline values, population averages, patient specific averages, or the like in order to determine which parameters or combinations of parameters are more effective than others in mitigating pain.

In some examples, a timing of parameter variations and the objection physiological measurements related the pain response of the worker may be used to determine a temporal uncertainty in the effects of the parameters on the objective physiological measurements, which may help determine a time course for pain mitigation effects through experimentation as well as whether particular parameters or objective physiological measurements are leading or lagging indicators of the pain experienced by the worker. In some cases, the parameters may be systematically varied across different trials to determine when there are deviations in the magnitude of the effect on the objective physiological measurement. Such effects may be caused by interactions among the parameters and/or decay of the previous parameter's effect. In some examples, when the time courses are established in this way, the results may also be used to associate particular parameters with the respective effects on pain mitigation once the time courses are known with a high degree of confidence (e.g., 95% confidence intervals). For example, algorithms to direct the variation of parameters to isolate temporal effects, including varying combinations of parameters, while holding certain aspects of the AR or VR display steady across multiple trials and/or varying the duration of time between the introduction of particular parameters may be used to determine the particular pain mitigation effects of various AR or VR displays.

The parameters of the AR or VR display may include the overall type of environment displayed (e.g., a snow world or an underwater world) and/or specific parameters within a type of environment (e.g., whether snow is falling in the snow world, whether animals or people are present in the environment, specific actions of animals or people within the environment, etc.). In some examples, the parameters may be selected based on constrained and/or weighted randomization, in which a likelihood that a particular parameter may have a greater effect on pain mitigation may be determined based on historical data, confidence intervals, or the like. In some examples, the parameters may be defined as a point in multidimensional space, in which each dimension corresponds to a feature of the parameter, such as, for example, a timing of the parameter, an order of the parameters presented, or the like. Such multidimensional analysis may enable the pain score to reflect the pain mitigation effects of a single parameter or a combination of parameters.

In some cases, the parameters may also be interactive (e.g., similar to the gesture inputs as described with respect to FIGS. 6A and 6B). For example, the AR or VR display may be presented as a game, a puzzle, a platform, a simulation, a sport, a role-playing environment, or the like. In some such examples, the parameters that are varied may include challenges or tasks within the interactive environment, scoring criteria, level of difficulty, control schemes, or combinations thereof.

In some cases, information relating to the pain mitigation effectiveness of the AR or VR display (e.g., parameters or combinations of parameters) may then be used to drive future AR or VR displays for pain mitigation, such as based on the likelihood that a particular parameter or combination of parameters will be effective for pain mitigation. In some examples, the pain mitigation information may be used to associate specific parameters of the AR or VR display with a particular type of pain mitigation, such as pain mitigation during burn treatment.

Any of the examples described herein may be able to be used individually or in combination in an AR display. Moreover, although described with respect to AR display device 49, additional or alternative articles of PPE or other AR devices may be used to present an AR display. For example, safety glasses (e.g., safety glasses 14 of FIG. 1), a face shield (e.g., of a powered air purifying respirators (PAPR)), a welding mask, or any other article of PPE may be used in accordance with the techniques of the disclosure. In addition, any of the articles of PPE (e.g., safety glasses 14 and/or AR display device 49), WSMS 6, a separate AR display device, communication hubs 13, safety stations 15, a cloud-based platform or server, an environmental device, a mobile device, or any other computing device may be used to perform one or more of the techniques described herein, store any data or information described herein, or both.

In some examples, as described above, context data may be used to along with the techniques of the disclosure. Such context data may include, but is not limited to, information about a hazard or safety event (e.g., type, severity, amount, etc.), one or more workers (e.g., location, motion, physiological, training, experience, PPE compliance record, etc.), an environment (e.g., location, type, size, risk level, hazard level, etc.), a machine or object (e.g., type, machine operation, status, training required, etc.), an article of PPE (e.g., type, service life, training requirements, inspection history, etc.), combinations thereof, or any other context data described herein.

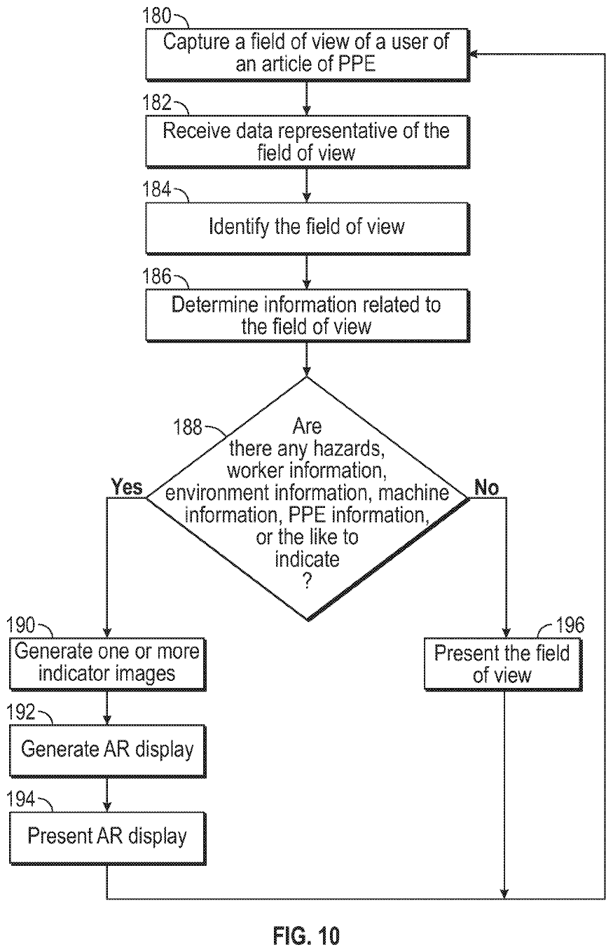

FIG. 10 is a flow diagram illustrating an example technique of presenting an AR display on an AR display device, in accordance with various techniques of the disclosure. The technique of FIG. 10 will be described with respect to the operating perspective of the worker safety management system of FIG. 2. In other examples, however, other systems may be used to perform to perform the technique of FIG. 10.

Safety glasses 14 (or another AR display device such as AR display device of FIG. 3) may capture a field of view of worker 10 within a work environment (e.g., work environment 8B of FIG. 1) (180). For example, a camera or another sensor on safety glasses 14 may be configured to capture an image, a video, or other information representative of the field of view of worker 10. Safety glasses 14, communication hub 13, or another client device 30 may then send the information representative of the captured field of view to WSMS 6. WSMS 6 may receive the information representative of the field of view (182).

Field of view analyzer 40A may then identify the field of view based on the information representative of the field of view received from safety glasses 14 or another client device 30 (184). For example, field of view analyzer 40A may receive the images, a video, or other information representative of the field of view and may read information stored in landmark data repository 48A to identify the field of view. In addition, or as an alternative, field of view analyzer 40A may use other information, such as a location of worker 10, a job site within work environment 8B worker 10 is scheduled to work at, sensing data of other articles of PPE, tags or identification information within the field of view, or the like to identify the field of view of the worker 10.

The technique of FIG. 10 further includes information processor 40B determining information relating to the field of view (186). For example, information processor 40B may determine potential hazards, safety events, presence of workers 10, machine or equipment statuses, PPE information, location information, instructions, task lists, or other information relating to the field of view. In some examples, information processor 40B may read such information relating to the field of view from safety data repository 48B and/or worker data repository 48C. For example, safety data repository 48B may include data relating to recorded safety events, sensed environmental conditions, worker indicated hazards, machine or equipment statuses, emergency exit information, safe navigation paths, proper PPE use instructions, service life or condition of articles of PPE, horizon or ground level indicators, boundaries, hidden structure information, or the like, and worker data repository 48C may include identification information of workers 10, PPE required for workers 10, PPE required for various work environments 8, articles of PPE that workers 10 have been trained to use, information pertaining to various sizes of one or more articles of PPE for workers 10, locations of workers, paths workers 10 have followed, gestures or annotations input by workers 10, machine or equipment training of workers 10, location restrictions of workers 10, task lists for specific workers 10, compliance information of workers 10, physiological information of workers 10, motions of workers 10, or the like.

Based on the information relating to the field of view, such as the information from safety data repository 48B and/or worker data repository 48C, information processor 40B may determine if there are any safety events, hazards, worker information, environment information, machine information, PPE information, or the like to indicate to worker 10 via an AR display of safety glasses 14 (188). If information processor 40B determines that there is relevant information about the field of view to indicate to worker 10 via the AR display of safety glasses 14 (YES branch of block 188), indicator image generator 40C may generate one or more indicator images (or commands for constructing images) related to the information relevant to the field of view (190). For example, indicator image generator 40C may generate a symbol, a list, a notification or alert, an information box, a status indicator, a path, a ranking or severity indicator, an outline, a horizon line, an instruction box, or the like. Indicator image generator 40C may generate the one or more indicator images by using a previously stored indicator image (e.g., an indicator image stored in AR display data repository 48D), modifying a previously stored indicator image, and/or rendering a new indicator image.

AR display generator 40D may then generate the AR display for presentation via safety glasses 14 and/or may output commands to cause the construction of the images by safety glasses (192). AR display generator 40D may generate the AR display including at least the one or more indicator images. For example, AR display generator 40D may arrange the one or more indicator images in a configuration based on the determined field of view such that the one or more indicator images will overlay and/or obscure the desired portion of the field of view when presented via safety glasses 14. Safety glasses 14 may present the AR display generated by AR display generator 40D (e.g., including at least the one or more indicator images, such as the one or more indicator images overlaid on the field of view) (194).

If information processor 40B determines that there is not relevant information about the field of view to indicate to worker 10 via the AR display of safety glasses 14 (NO branch of block 188), safety glasses 14 may present the field of view (196). For example, safety glasses 14 may present the originally captured field of view as seen through safety glasses 14 without one or more indicator images.

In some examples, the technique of FIG. 10 may be repeated any number of times while worker 10 is wearing safety glasses 14. For example, safety glasses 14 capture a second field of view different that a first field of view, field of view analyzer 40A may identify the second field of view, information processor 40B may determine a second set of information relating to the second field of view, indicator image generator 40C may generate a second set of indicator images related to the determined information of the second field of view, and AR display generator 40D may generate a second AR display including at least the second set of indicator images.

It will be appreciated that numerous and varied other arrangements may be readily devised by those skilled in the art without departing from the spirit and scope of the invention as claimed. For example, each of the communication modules in the various devices described throughout may be enabled to communicate as part of a larger network or with other devices to allow for a more intelligent infrastructure. Information gathered by various sensors may be combined with information from other sources, such as information captured through a video feed of a work space or an equipment maintenance space. Thus, additional features and components can be added to each of the systems described above without departing from the spirit and scope of the invention as claimed.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A system comprising:
an article of personal protective equipment (PPE) configured to present an (AR) augmented reality display to a user; and
at least one computing device comprising a memory and one or more processors coupled to the memory, wherein the memory comprises instructions that when executed by the one or more processors:
identify a field of view of the user;
determine information relating to the field of view of the user;
generate one or more indicator images related to the determined information of the field of view; and
generate the AR display including at least the one or more indicator images.

2. The system of claim 1, wherein the memory further comprises instructions that when executed by the one or more processors present, via the article of PPE, the AR display including at least the one or more indicator images.

3. The system of claim 1, wherein the memory further comprises instructions that when executed by the one or more processors to receive, from the article of PPE, information representative of the field of view of the user, and wherein the field of view is identified based on the received information representative of the field of view.

4. The system of claim 1, wherein determining the information related to the field of view of the user comprises determining at least one of information related to a safety event, a potential hazard, another worker, an article of PPE, a machine, a non-visible portion of the field of view, a path, or a task.

5. The system of claim 1, wherein determining the information related to the field of view of the user comprises determining the information based on the identified field of view and context data related to the field of view.

6. The system of claim 1, wherein the one or more indicator images comprise at least one of a symbol, a list, a notification, an information box, a status indicator, a path, a ranking or severity indicator, an outline, a horizon line, or an instruction box.

7. The system of claim 1, wherein the memory further comprises instructions that when executed by the one or more processors:
receive a gesture input within the field of view by the user, and
identify the gesture input.

8. The system of claim 7, wherein the memory further comprises instructions that when executed by the one or more processors generate one or more indicator images based on the identified gesture input.

9. The system of claim 8, wherein the article of PPE configured to present the AR display comprises a first article of PPE, the user comprises a first user, and the AR display comprises a first AR display, and wherein the memory further comprises instructions that when executed by the one or more processors present, via a second article of PPE configured to present a second AR display to a second user, the second AR display including the one or more indicator images generated based on the identified gesture input of the first user.

10. The system of claim 1, wherein the field of view comprises a first field of view, the information relating to the field of view comprises a first set of information, the one or more indicator images comprises a first set of indicator images, and the AR display comprises a first AR display, and wherein the memory further comprises instructions that when executed by the one or more processors:
identify a second field of view of the user, wherein the second field of view is different than the first field of view;
determine a second set of information relating to the second field of view of the user;
generate a second set of indicator images related to the determined information of the second field of view; and
generate a second AR display including at least the second set of indicator images.

11. The system of claim 1, wherein the AR display is configured to overlay the one or more indicator images over the field of view.

12. The system of claim 1, wherein the article of PPE comprises at least one of safety glasses, a welding mask, a face shield, or another article of PPE configured to display an augmented reality display of a work environment in which the user is viewing.

13. A method, comprising:
identifying a field of view of a user;
determining information relating to the field of view of the user;
generating one or more indicator images related to the determined information of the field of view; and
generating an augmented reality (AR) display including at least the one or more indicator images.

14. The method of claim 13, further comprising presenting the AR display including at least the one or more indicator images.

15. The method of claim 14, wherein the AR display is presented via an article of personal protection equipment (PPE), and wherein the article of PPE comprises at least one of safety glasses, a welding mask, a face shield, or another article of PPE configured to display an augmented reality display of a work environment in which the user is viewing.

16. The method of claim 13, further comprising receiving information representative of the field of view of the user, and wherein identifying the field of view of the user comprises identifying the field of view of the user based on the received information representative of the field of view.

17. The method of claim 13, wherein determining the information related to the field of view of the user comprises determining at least one of information related to a safety event, a potential hazard, another worker, an article of PPE, a machine, a non-visible portion of the field of view, a path, or a task.

18. The method of claim 13, wherein determining the information related to the field of view of the user comprises determining the information based on the identified field of view and context data related to the field of view.

19. The method of claim 13, wherein generating the one or more indicator images comprises generating at least one of a symbol, a list, a notification, an information box, a status indicator, a path, a ranking or severity indicator, an outline, a horizon line, of an instruction box.

20. The method of claim 13, further comprising:
receiving a gesture input by the user, and
identifying the gesture input.

21-30. (canceled)
